(19) United States
(12) Patent Application Publication
(10) Pub. No.: US 2025/0267635 A1
(43) Pub. Date: Aug. 21, 2025

(54) SUBBAND FULL DUPLEX SYMBOL INFORMATION VIA SLOT FORMAT INDICATORS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US); Peter GAAL, San Diego, CA (US)

(21) Appl. No.: 18/443,093

(22) Filed: Feb. 15, 2024

(51) Int. Cl. H04W 72/0446; H04L 5/14; H04W 72/232

(52) U.S. Cl. CPC H04W 72/0446; H04L 5/14; H04W 72/232

(57) ABSTRACT

Methods, systems, and devices for wireless communications are described. The described techniques may enable a network entity to transmit a slot format indicator (SFI) to assign a subband full duplex (SBFD) symbol as a downlink symbol, an uplink symbol, or a flexible symbol. The SFI may indicate for a wireless device to fallback to a downlink time division duplex (TDD) slot format, an uplink time division duplex (TDD) slot format, or a flexible TDD slot format. In some examples, the network entity may transmit an SFI configuring the wireless device with a symbol pattern that may include an SBFD symbol type. Additionally, or alternatively, the wireless device may be configured with one or more time patterns, and the SFI may indicate a time pattern of the one or more time patterns for the wireless device to apply to one or more symbols.

### FIELD OF TECHNOLOGY

The following relates to wireless communications, including subband full duplex (SBFD) symbol information via slot format indicators (SFIs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support SBFD symbol information via SFIs. For example, the described techniques may enable a network entity to transmit an SFI to a wireless device to assign an SBFD symbol as a downlink symbol, an uplink symbol, or a flexible symbol. The SFI may indicate for the wireless device to fallback to a downlink time division duplex (TDD) slot format, an uplink TDD slot format, or a flexible TDD slot format. In some examples, the SFI may indicate that an SBFD symbol is reserved, and the wireless device may not communicate (e.g., refrain from receiving a downlink communication or transmitting an uplink communication, or both) via the downlink or flexible subbands and/or the uplink subbands.

In some examples, the network entity may transmit an SFI configuring the wireless device with a symbol pattern that may include an SBFD symbol type. That is, the wireless device may receive a configuration for an SFI table, or other data structure, indicating a set of symbol formats including an SBFD symbol format. Accordingly, the SFI may indicate for the wireless device to use an SBFD symbol format. Additionally, or alternatively, the wireless device may be configured with one or more time patterns (e.g., patterns of slots including SBFD symbols), and the SFI may indicate a time pattern of the one or more time patterns for the wireless device to apply to one or more symbols.

A method for wireless communications by a UE is described. The method may include receiving control signaling that indicates a configuration including a set of one or more SBFD symbols, where the set of one or more SBFD symbols are configured in one or more TDD downlink symbols or one or more time division duplexing (TDD) flexible symbols, monitoring for downlink control information (DCI) including a SFI, where the SFI indicates each of one or more SBFD symbols of the set of one or more SBFD symbols as downlink, uplink, or flexible, and performing wireless communication according to one or more of the configuration or the SFI.

A UE for wireless communications is described. The UE may include one or more memories storing processor executable code, and one or more processors coupled with the one or more memories. The one or more processors may individually or collectively be operable to execute the code to cause the UE to receive control signaling that indicates a configuration including a set of one or more SBFD symbols, where the set of one or more SBFD symbols are configured in one or more TDD downlink symbols or one or more TDD flexible symbols, monitor for DCI including a SFI, where the SFI indicates each of one or more SBFD symbols of the set of one or more SBFD symbols as downlink, uplink, or flexible, and perform wireless communication according to one or more of the configuration or the SFI.

Another UE for wireless communications is described. The UE may include means for receiving control signaling that indicates a configuration including a set of one or more SBFD symbols, where the set of one or more SBFD symbols are configured in one or more TDD downlink symbols or one or more TDD flexible symbols, means for monitoring for DCI including a SFI, where the SFI indicates each of one or more SBFD symbols of the set of one or more SBFD symbols as downlink, uplink, or flexible, and means for performing wireless communication according to one or more of the configuration or the SFI.

A non-transitory computer-readable medium storing code for wireless communications is described. The code may include instructions executable by one or more processors to receive control signaling that indicates a configuration including a set of one or more SBFD symbols, where the set of one or more SBFD symbols are configured in one or more TDD downlink symbols or one or more TDD flexible symbols, monitor for DCI including a SFI, where the SFI indicates each of one or more SBFD symbols of the set of one or more SBFD symbols as downlink, uplink, or flexible, and perform wireless communication according to one or more of the configuration or the SFI.

In some examples of the method, UE, and non-transitory computer-readable medium described herein, the set of one or more SBFD symbols may be configured in the one or more TDD downlink symbols or the one or more TDD flexible symbols by converting the one or more TDD downlink symbols or the one or more TDD flexible symbols to one or more SBFD symbols.

In some examples of the method, UE, and non-transitory computer-readable medium described herein, performing wireless communication may include operations, features, means, or instructions for receiving a downlink communication via one or more downlink subbands associated with the set of one or more SBFD symbols, where the downlink communication includes one or more of a physical downlink control channel (PDCCH) transmission, a physical downlink shared channel (PDSCH) transmission, a channel state information reference signal (CSI-RS) transmission, or a positioning reference signal (PRS) transmission.

In some examples of the method, UE, and non-transitory computer-readable medium described herein, performing wireless communication may include operations, features, means, or instructions for transmitting an uplink communication via one or more uplink subbands associated with the set of one or more SBFD symbols, where the uplink communication includes one or more of a physical uplink control channel (PUCCH) transmission, a physical uplink shared channel (PUSCH) transmission, a sounding reference signal (SRS) transmission, or a physical random access channel (PRACH) transmission.

In some examples of the method, UE, and non-transitory computer-readable medium described herein, performing wireless communication may include operations, features, means, or instructions for receiving a downlink communication or transmitting an uplink communication based on a corresponding DCI, where receiving the downlink communication may be based on canceling the uplink communication associated with one or more uplink subbands, and where transmitting the uplink communication may be based on dropping the downlink communication associated with one or more downlink subbands.

In some examples of the method, UE, and non-transitory computer-readable medium described herein, the configuration indicates that one or more SBFD symbols of the set of one or more SBFD symbols may be configured in the one or more TDD downlink symbol and the method, apparatuses, and non-transitory computer-readable medium may include further operations, features, means, or instructions for refraining from receiving a downlink communication or transmitting an uplink communication via the set of one or more SBFD symbols indicated as flexible.

In some examples of the method, UE, and non-transitory computer-readable medium described herein, performing wireless communication may include operations, features, means, or instructions for receiving a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples of the method, UE, and non-transitory computer-readable medium described herein, performing wireless communication may include operations, features, means, or instructions for receiving a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples of the method, UE, and non-transitory computer-readable medium described herein, performing wireless communication may include operations, features, means, or instructions for transmitting an uplink communication via one or more uplink subbands associated with the set of one or more SBFD symbols, where the uplink communication includes one or more of a PUCCH transmission, an PUSCH transmission, an SRS transmission, or a physical random access channel (PRACH) transmission configured by higher-layer signaling.

In some examples of the method, UE, and non-transitory computer-readable medium described herein, performing wireless communication may include operations, features, means, or instructions for transmitting an uplink communication via one or more uplink subbands and one or more flexible subbands associated with the set of one or more SBFD symbols, where the uplink communication includes one or more of a PUCCH transmission, an PUSCH transmission, an SRS transmission, or a PRACH transmission.

Some examples of the method, UE, and non-transitory computer-readable medium described herein may further include operations, features, means, or instructions for determining an absence of the SFI that indicates each of one or more SBFD symbols of the set of one or more SBFD symbols as flexible.

In some examples of the method, UE, and non-transitory computer-readable medium described herein, performing wireless communication may include operations, features, means, or instructions for receiving a downlink communication via one or more TDD downlink symbols based on the SFI indicates each of one or more SBFD symbols of the set of one or more SBFD symbols as downlink.

In some examples of the method, UE, and non-transitory computer-readable medium described herein, performing wireless communication may include operations, features, means, or instructions for performing the wireless communication via the one or more SBFD symbols or one or more TDD flexible symbols.

In some examples of the method, UE, and non-transitory computer-readable medium described herein, performing wireless communication may include operations, features, means, or instructions for transmitting one or more messages via the one or more SBFD symbols.

In some examples of the method, UE, and non-transitory computer-readable medium described herein, performing wireless communication may include operations, features, means, or instructions for performing an uplink communication irrespective of the SFI and declaring an error associated with configuring the one or more SBFD symbols of the set of one or more SBFD symbols in the one or more TDD flexible symbols or the one or more TDD downlink symbols.

A method for wireless communications by a UE is described. The method may include receiving control signaling that indicates a configuration including a set of one or more symbols, where the configuration indicates one or more symbols of the set of one or more symbols as downlink or flexible, receiving DCI including a SFI, where the SFI indicates each of one or more symbols of the set of one or more symbols as TDD downlink symbols, TDD flexible symbols, or SBFD symbols, and performing wireless communication according to one or more of the configuration or the SFI.

A UE for wireless communications is described. The UE may include one or more memories storing processor executable code, and one or more processors coupled with the one or more memories. The one or more processors may individually or collectively be operable to execute the code to cause the UE to receive control signaling that indicates a configuration including a set of one or more symbols, where the configuration indicates one or more symbols of the set of one or more symbols as downlink or flexible, receive DCI including a SFI, where the SFI indicates each of one or more symbols of the set of one or more symbols as TDD downlink symbols, TDD flexible symbols, or SBFD symbols, and perform wireless communication according to one or more of the configuration or the SFI.

Another UE for wireless communications is described. The UE may include means for receiving control signaling that indicates a configuration including a set of one or more symbols, where the configuration indicates one or more symbols of the set of one or more symbols as downlink or flexible, means for receiving DCI including a SFI, where the SFI indicates each of one or more symbols of the set of one or more symbols as TDD downlink symbols, TDD flexible symbols, or SBFD symbols, and means for performing wireless communication according to one or more of the configuration or the SFI.

A non-transitory computer-readable medium storing code for wireless communications is described. The code may include instructions executable by one or more processors to receive control signaling that indicates a configuration including a set of one or more symbols, where the configuration indicates one or more symbols of the set of one or more symbols as downlink or flexible, receive DCI including a SFI, where the SFI indicates each of one or more symbols of the set of one or more symbols as TDD downlink symbols, TDD flexible symbols, or SBFD symbols, and perform wireless communication according to one or more of the configuration or the SFI.

In some examples of the method, UE, and non-transitory computer-readable medium described herein, the configuration includes at least one SFI table including one or more entries indicatives of the set of one or more symbols as one or more of downlink, uplink, flexible, or SBFB.

Some examples of the method, UE, and non-transitory computer-readable medium described herein may further include operations, features, means, or instructions for receiving a radio resource control signaling that indicates a second configuration including a set of one or more SBFD symbol patterns and where performing wireless communication may be based on at least one SBFD symbol pattern of the set of one or more SBFD symbol patterns.

In some examples of the method, UE, and non-transitory computer-readable medium described herein, the SFI includes a bitfield that enables the at least one SBFD symbol pattern of the set of one or more SBFD symbol patterns.

In some examples of the method, UE, and non-transitory computer-readable medium described herein, the at least one SBFD symbol pattern of the set of one or more SBFD symbol patterns may be applicable to one or more symbols associated with the SFI and the at least one SBFD symbol pattern may be applicable until a second SFI enables at least one second SBFD symbol pattern of the set of one or more SBFD symbol patterns.

A method for wireless communications by a network entity is described. The method may include transmitting control signaling that indicates a configuration including a set of one or more SBFD symbols, where the set of one or more SBFD symbols are configured in one or more TDD downlink symbols or one or more TDD flexible symbols, transmitting DCI including a SFI, where the SFI indicates each of one or more SBFD symbols of the set of one or more SBFD symbols as downlink, uplink, or flexible, and performing wireless communication according to one or more of the configuration or the SFI.

A network entity for wireless communications is described. The network entity may include one or more memories storing processor executable code, and one or more processors coupled with the one or more memories. The one or more processors may individually or collectively be operable to execute the code to cause the network entity to transmit control signaling that indicates a configuration including a set of one or more SBFD symbols, where the set of one or more SBFD symbols are configured in one or more TDD downlink symbols or one or more TDD flexible symbols, transmit DCI including a SFI, where the SFI indicates each of one or more SBFD symbols of the set of one or more SBFD symbols as downlink, uplink, or flexible, and perform wireless communication according to one or more of the configuration or the SFI.

Another network entity for wireless communications is described. The network entity may include means for transmitting control signaling that indicates a configuration including a set of one or more SBFD symbols, where the set of one or more SBFD symbols are configured in one or more TDD downlink symbols or one or more TDD flexible symbols, means for transmitting DCI including a SFI, where the SFI indicates each of one or more SBFD symbols of the set of one or more SBFD symbols as downlink, uplink, or flexible, and means for performing wireless communication according to one or more of the configuration or the SFI.

A non-transitory computer-readable medium storing code for wireless communications is described. The code may include instructions executable by one or more processors to transmit control signaling that indicates a configuration including a set of one or more SBFD symbols, where the set of one or more SBFD symbols are configured in one or more TDD downlink symbols or one or more TDD flexible symbols, transmit DCI including a SFI, where the SFI indicates each of one or more SBFD symbols of the set of one or more SBFD symbols as downlink, uplink, or flexible, and perform wireless communication according to one or more of the configuration or the SFI.

In some examples of the method, network entities, and non-transitory computer-readable medium described herein, the set of one or more SBFD symbols may be configured in the one or more TDD downlink symbols or the one or more TDD flexible symbols by converting the one or more TDD downlink symbols or the one or more TDD flexible symbols to one or more SBFD symbols.

In some examples of the method, network entities, and non-transitory computer-readable medium described herein, performing wireless communication may include operations, features, means, or instructions for transmitting a downlink communication via one or more downlink subbands associated with the set of one or more SBFD symbols, where the downlink communication includes one or more of a PDCCH transmission, an PDSCH transmission, a CSI-RS transmission, or a PRS transmission.

In some examples of the method, network entities, and non-transitory computer-readable medium described herein, performing wireless communication may include operations, features, means, or instructions for receiving an uplink communication via one or more uplink subbands associated with the set of one or more SBFD symbols, where the uplink communication includes one or more of a PUCCH transmission, an PUSCH transmission, an SRS transmission, or a physical random access channel (PRACH) transmission.

In some examples of the method, network entities, and non-transitory computer-readable medium described herein, performing wireless communication may include operations, features, means, or instructions for transmitting a downlink communication or transmitting an uplink communication based on a corresponding DCI, where receiving the downlink communication may be based on canceling the uplink communication associated with one or more uplink subbands, and where transmitting the uplink communication may be based on dropping the downlink communication associated with one or more downlink subbands.

In some examples of the method, network entities, and non-transitory computer-readable medium described herein, performing wireless communication may include operations, features, means, or instructions for transmitting a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples of the method, network entities, and non-transitory computer-readable medium described herein, performing wireless communication may include operations, features, means, or instructions for transmitting a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples of the method, network entities, and non-transitory computer-readable medium described herein, performing wireless communication may include operations, features, means, or instructions for receiving an uplink communication via one or more uplink subbands associated with the set of one or more SBFD symbols, where the uplink communication includes one or more of a PUCCH transmission, an PUSCH transmission, an SRS transmission, or a physical random access channel (PRACH) transmission configured by higher-layer signaling.

In some examples of the method, network entities, and non-transitory computer-readable medium described herein, performing wireless communication may include operations, features, means, or instructions for receiving an uplink communication via one or more uplink subbands and one or more flexible subbands associated with the set of one or more SBFD symbols, where the uplink communication includes one or more of a PUCCH transmission, an PUSCH transmission, an SRS transmission, or a physical random access channel (PRACH) transmission.

In some examples of the method, network entities, and non-transitory computer-readable medium described herein, performing wireless communication may include operations, features, means, or instructions for transmitting a downlink communication via one or more TDD downlink symbols based on the SFI indicates each of one or more SBFD symbols of the set of one or more SBFD symbols as downlink.

In some examples of the method, network entities, and non-transitory computer-readable medium described herein, performing wireless communication may include operations, features, means, or instructions for performing the wireless communication via the one or more SBFD symbols or one or more TDD flexible symbols.

In some examples of the method, network entities, and non-transitory computer-readable medium described herein, performing wireless communication may include operations, features, means, or instructions for receiving one or more messages via the one or more SBFD symbols.

In some examples of the method, network entities, and non-transitory computer-readable medium described herein, performing wireless communication may include operations, features, means, or instructions for performing an uplink communication irrespective of the SFI.

A method for wireless communications by a network entity is described. The method may include transmitting control signaling that indicates a configuration including a set of one or more symbols, where the configuration indicates one or more symbols of the set of one or more symbols as downlink or flexible, transmitting DCI including a SFI, where the SFI indicates each of one or more symbols of the set of one or more symbols as TDD downlink symbols, TDD flexible symbols, or SBFD symbols, and performing wireless communication according to one or more of the configuration or the SFI.

A network entity for wireless communications is described. The network entity may include one or more memories storing processor executable code, and one or more processors coupled with the one or more memories. The one or more processors may individually or collectively be operable to execute the code to cause the network entity to transmit control signaling that indicates a configuration including a set of one or more symbols, where the configuration indicates one or more symbols of the set of one or more symbols as downlink or flexible, transmit DCI including a SFI, where the SFI indicates each of one or more symbols of the set of one or more symbols as TDD downlink symbols, TDD flexible symbols, or SBFD symbols, and perform wireless communication according to one or more of the configuration or the SFI.

Another network entity for wireless communications is described. The network entity may include means for transmitting control signaling that indicates a configuration including a set of one or more symbols, where the configuration indicates one or more symbols of the set of one or more symbols as downlink or flexible, means for transmitting DCI including a SFI, where the SFI indicates each of one or more symbols of the set of one or more symbols as TDD downlink symbols, TDD flexible symbols, or SBFD symbols, and means for performing wireless communication according to one or more of the configuration or the SFI.

A non-transitory computer-readable medium storing code for wireless communications is described. The code may include instructions executable by one or more processors to transmit control signaling that indicates a configuration including a set of one or more symbols, where the configuration indicates one or more symbols of the set of one or more symbols as downlink or flexible, transmit DCI including a SFI, where the SFI indicates each of one or more symbols of the set of one or more symbols as TDD downlink symbols, TDD flexible symbols, or SBFD symbols, and perform wireless communication according to one or more of the configuration or the SFI.

In some examples of the method, network entities, and non-transitory computer-readable medium described herein, the configuration includes at least one SFI table including one or more entries indicatives of the set of one or more symbols as one or more of downlink, uplink, flexible, or SBFB.

Some examples of the method, network entities, and non-transitory computer-readable medium described herein may further include operations, features, means, or instructions for transmitting a radio resource control signaling that indicates a second configuration including a set of one or more SBFD symbol patterns and where performing wireless communication may be based on at least one SBFD symbol pattern of the set of one or more SBFD symbol patterns.

In some examples of the method, network entities, and non-transitory computer-readable medium described herein, the SFI includes a bitfield that enables the at least one SBFD symbol pattern of the set of one or more SBFD symbol patterns.

In some examples of the method, network entities, and non-transitory computer-readable medium described herein, the at least one SBFD symbol pattern of the set of one or more SBFD symbol patterns may be applicable to one or more symbols associated with the SFI and the at least one SBFD symbol pattern may be applicable until a second SFI enables at least one second SBFD symbol pattern of the set of one or more SBFD symbol patterns.

### BRIEF DESCRIPTION OF THE DRAWINGS

FIGS. 1 and 2 show examples of wireless communications systems that support SBFD symbol information via SFIs in accordance with one or more aspects of the present disclosure.

FIGS. 3 and 4 show examples of process flows that support SBFD symbol information via slot format indicators in accordance with one or more aspects of the present disclosure.

FIGS. 5 and 6 show block diagrams of devices that support SBFD symbol information via slot format indicators in accordance with one or more aspects of the present disclosure.

FIG. 7 shows a block diagram of a communications manager that supports SBFD symbol information via slot format indicators in accordance with one or more aspects of the present disclosure.

FIG. 8 shows a diagram of a system including a device that supports SBFD symbol information via slot format indicators in accordance with one or more aspects of the present disclosure.

FIGS. 9 and 10 show block diagrams of devices that support SBFD symbol information via slot format indicators in accordance with one or more aspects of the present disclosure.

FIG. 11 shows a block diagram of a communications manager that supports SBFD symbol information via slot format indicators in accordance with one or more aspects of the present disclosure.

FIG. 12 shows a diagram of a system including a device that supports SBFD symbol information via slot format indicators in accordance with one or more aspects of the present disclosure.

FIGS. 13 through 16 show flowcharts illustrating methods that support SBFD symbol information via slot format indicators in accordance with one or more aspects of the present disclosure.

### DETAILED DESCRIPTION

A wireless communication system may support duplex communications, in which wireless devices (e.g., a UE, a network entity) may perform wireless communication. In some cases, the wireless communication system may support TDD communications, in which the wireless devices may perform wireless communication (e.g., downlink communication, uplink communication) on a same frequency resource (e.g., a single radio frequency, a single radio frequency subband, a single radio frequency band) and over one or multiple different time resources (e.g., symbols, slots). TDD techniques may thereby enable both downlink communication and uplink communication over a same frequency resource and using different time resources (e.g., symbols, slots) for each of the wireless devices. In some other cases, the wireless communication system may support SBFD communications, in which the wireless devices may perform downlink communication over a downlink or flexible subband and uplink communication over an uplink subband in a same time resource (e.g., a same symbol, a same slot). SBFD techniques may enable higher throughput and reduced latency for uplink communications as compared to TDD techniques, wherein most time resources (e.g., symbols, slots) may be allocated for downlink communication.

In some examples, a network entity may configure a wireless device (e.g., a UE) with a symbol pattern that designates one or more time resources (e.g., symbols, slots) as TDD uplink resources, TDD downlink resources, and/or TDD flexible resources. The wireless device may receive a configuration that indicates for the wireless device to use one or more of the TDD downlink resources or the TDD flexible resources as SBFD resources (e.g., SBFD symbols, SBFD slots). Additionally, or alternatively, the network entity may transmit a SFI to the wireless device, which may assign one or more of the time resources (e.g., TDD flexible symbols) as a downlink symbol, an uplink symbol, or a flexible symbol. However, for a wireless device supporting SBFD symbols, the wireless device may not expect (e.g., monitor for) an SFI indicating a slot format for one or more SBFD symbols or one or more subbands (e.g., flexible subbands) within an SBFD symbol.

Various aspects of the present disclosure relate to enabling an SFI to assign an SBFD symbol as a downlink symbol, an uplink symbol, or a flexible symbol. A network entity may transmit an SFI indicating for a wireless device (e.g., a UE) to receive via one or more downlink subbands or flexible subbands within an SBFD symbol (e.g., and to refrain from transmitting via uplink subbands) or to transmit via the uplink subbands (e.g., and to refrain from using the downlink or flexible subbands). The SFI may indicate for the wireless device to fallback to a downlink TDD slot format, an uplink TDD slot format, or a flexible TDD slot format. In some examples, the SFI may indicate that an SBFD symbol is reserved, and the wireless device may not communicate via the downlink or flexible subbands and/or the uplink subbands.

In some examples, the network entity may transmit an SFI configuring the wireless device with a symbol pattern which may include an SBFD symbol type. That is, the wireless device may receive a configuration for an SFI table with a set of symbol formats including an SBFD symbol format. Accordingly, the SFI may indicate for the wireless device to use an SBFD symbol format. Additionally, or alternatively, the wireless device may be configured with one or more time patterns (e.g., patterns of slots including SBFD symbols), and the SFI may indicate a time pattern of the one or more time patterns for the wireless device to apply to one or more symbols.

Aspects of the disclosure are initially described in the context of wireless communications systems. Aspects of the disclosure are further illustrated by and described with reference to process flow diagrams, apparatus diagrams, system diagrams, and flowcharts that relate to SBFD symbol information via SFIs.

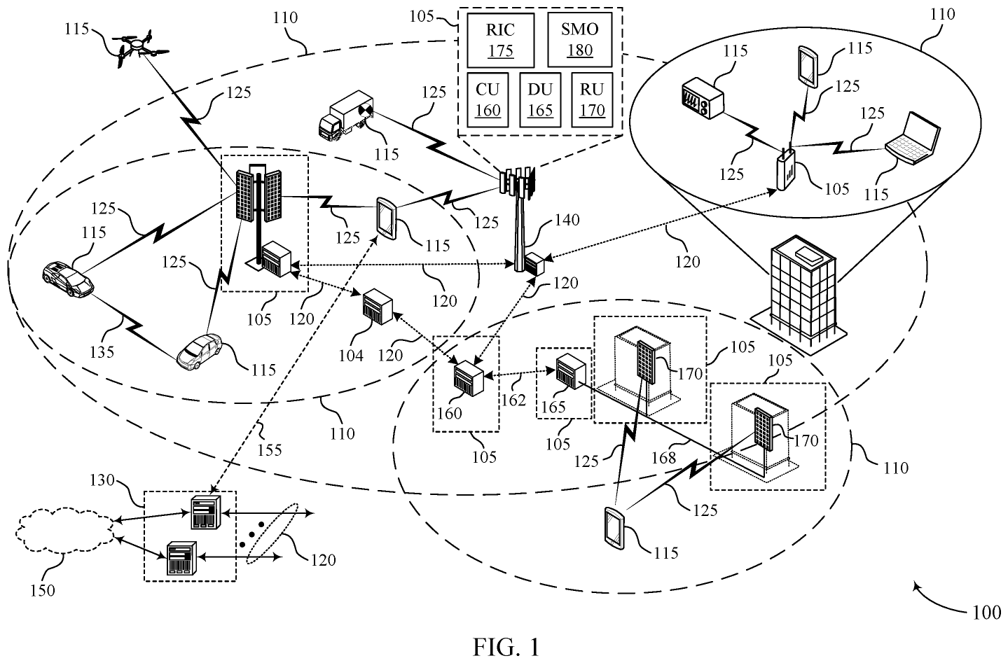

FIG. 1 shows an example of a wireless communications system 100 that supports SBFD symbol information via SFIs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and Ues 115 may wirelessly communicate via communication link(s) 125 (e.g., a radio frequency (RF) access link). For example, a network entity 105 may support a coverage area 110 (e.g., a geographic coverage area) over which the Ues 115 and the network entity 105 may establish the communication link(s) 125. The coverage area 110 may be an example of a geographic area over which a network entity 105 and a UE 115 may support the communication of signals according to one or more radio access technologies (RATs).

The Ues 115 may be dispersed throughout a coverage area 110 of the wireless communications system 100, and each UE 115 may be stationary, or mobile, or both at different times. The Ues 115 may be devices in different forms or having different capabilities. Some example Ues 115 are illustrated in FIG. 1. The Ues 115 described herein may be capable of supporting communications with various types of devices in the wireless communications system 100 (e.g., other wireless communication devices, including Ues 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more Cus) may be connected to a DU 165 (e.g., one or more Dus) or an RU 170 (e.g., one or more Rus), or some combination thereof, and the Dus 165, Rus 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different Rus, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more Dus (e.g., Dus 165) of a coupled IAB donor. An IAB-MT may be equipped with an independent set of antennas for relay of communications with Ues 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more Dus (e.g., Dus 165) that support communication links with additional entities (e.g., IAB node(s) 104, Ues 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The Ues 115 described herein may be able to communicate with various types of devices, such as Ues 115 that may sometimes operate as relays, as well as the network entities 105 and the network equipment including macro eNBs or gNBs, small cell eNBs or gNBs, or relay base stations, among other examples, as shown in FIG. 1.

The Ues 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the Ues 115. A carrier may be operated in a standalone mode, in which case initial acquisition and connection may be conducted by the Ues 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the Ues 115, or both) may have hardware configurations that support communications using a particular carrier bandwidth or may be configurable to support communications using one of a set of carrier bandwidths. In some examples, the wireless communications system 100 may include network entities 105 or Ues 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the Ues 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the Ues 115. For example, one or more of the Ues 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to Ues 115 (e.g., one or more Ues) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The Ues 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other Ues (e.g., one or more of the Ues 115) via a device-to-device (D2D) communication link, such as a D2D communication link 135 (e.g., in accordance with a peer-to-peer (P2P), D2D, or sidelink protocol). In some examples, one or more Ues 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more Ues 115 of such a group may be outside the coverage area 110 of a network entity 105 or may be otherwise unable to or not configured to receive transmissions from a network entity 105. In some examples, groups of the Ues 115 communicating via D2D communications may support a one-to-many (1:M) system in which each UE 115 transmits to one or more of the Ues 115 in the group. In some examples, a network entity 105 may facilitate the scheduling of resources for D2D communications. In some other examples, D2D communications may be carried out between the Ues 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the Ues 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the Ues 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the Ues 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the Ues 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support full-duplex communications, in which a UE 115 or a network entity 105 may perform simultaneous downlink communication and uplink communication on a frequency subband basis (e.g., across a set of frequencies). For example, the UE 115 may partition a particular band (e.g., 100 MHz) into sub-bands, which the UE 115 may use exclusively for uplink communication or downlink communication. For example, the UE 115 may use the 40 MHz of a 100 MHz band for downlink communications, 20 MHz for uplink communications, and another 40 MHz again for downlink communications. That is, the uplink and downlink bands may have relatively similar frequencies, however, may be non-overlapping in frequency. Full-duplex communications may be suitable for macro cells with a large transmit power, and may be relatively simpler to enable than other full-duplex techniques. In addition, full-duplex communications may improve latency and increase uplink coverage via frequency division duplexing (FDD) in TDD bands.

To further enhance flexibility of some operations, the wireless communications system 100 may support Ues 115 and network entities 105 which may both perform simultaneous transmission and reception of downlink and uplink communications via partially or fully overlapping frequency bands. For example, the wireless communications system 100 may support a UE 115 and a network entity 105 that operate using full-duplex communications via partially overlapping frequency bands, or a network entity 105 that operates using half-duplex communications (e.g., in a multi-transmission reception point (mTRP)) scenario) and a UE 115 that operates using full-duplex communications.

In a TDD scenario, network entities 105 in the wireless communications system 100 may support full-duplex operations (e.g., where a network entity 105 may communicate simultaneously on uplink and downlink sub-bands that are non-overlapping in frequency), while Ues 115 may support half-duplex communications. For example, the network entity 105 may use a particular sub-band for transmitting downlink communications to a first UE 115, and a particular sub-band for receiving simultaneous uplink communications from a second UE 115. As such, a UE 115 capable of half-duplex communications may be paired with any network entity 105 capable of full-duplex operations in the wireless communications system 100.

In some examples, the network entity 105 may use IBFD communications, in which the network entity 105 may transmit and receive communications with a UE 115 via a same time resource and a same frequency resource. That is, the downlink and uplink may share same IBFD time and frequency resources, which may partially or fully overlap. Alternatively, the network entity 105 may use SBFD (e.g., flexible duplex) communications, in which the network entity 105 may transmit and receive communications with the UE 115 via a same time resource but via different frequency resources. That is, a frequency resource used for downlink communications may be separated from a frequency resource used for uplink communications (e.g., by a guard band).

In some examples, a network entity 105 may configure a UE 115 with a symbol pattern that designates one or more time resources (e.g., symbols, slots) as TDD uplink resources, TDD downlink resources, and/or TDD flexible resources. For example, the network entity 105 may transmit control signaling (e.g., RRC signaling, medium access control-control element (MAC-CE) signaling, DCI) including one or more parameters (e.g., tdd-UL-DL-ConfigurationCommon, tdd-ULDL-ConfigurationDedicated) that indicates one or more slots or symbols of a slot as uplink resources, downlink resources, or flexible resources. The UE 115 may receive a configuration that converts one or more of the TDD downlink symbols or the TDD flexible symbols as SBFD symbols.

Additionally, or alternatively, the network entity 105 may transmit a DCI message (e.g., a DCI with format 2_0). The DCI may include a SFI (e.g., in an SFI-index field of the DCI), which may assign one or more of the time resources (e.g., TDD flexible symbols) as a downlink symbol, an uplink symbol, or a flexible symbol. The UE 115 may not expect to receive a DCI (e.g., a DCI with format 2_0) with an SFI-index field value indicating a symbol format (e.g., uplink, downlink, or flexible) for one or more symbols configured as uplink or downlink by the one or more parameters (e.g., tdd-UL-DL-ConfigurationCommon, tdd-ULDL-ConfigurationDedicated), or for one or more symbols (e.g., TDD downlink symbols or TDD flexible symbols) that are converted to SBFD symbols.

The wireless communication system 100 may enable one or more of a network entity 105 or a base station 140 to assign, via an SFI, an SBFD symbol as a downlink symbol, an uplink symbol, or a flexible symbol. One or more of the network entity 105 or the base station 140 may transmit an SFI indicating for a UE 115 to receive via one or more downlink subbands or flexible subbands within an SBFD symbol (e.g., and to refrain from transmitting via uplink subbands) or to transmit via the uplink subbands (e.g., and to refrain from using the downlink or flexible subbands). The SFI may indicate for the UE 115 to fallback to a downlink TDD slot format, an uplink TDD slot format, or a flexible TDD slot format. In some examples, the SFI may indicate that an SBFD symbol is reserved, and the UE 115 may not communicate (e.g., refrain from communicating) via the downlink or flexible subbands and/or the uplink subbands.

In some examples, one or more of the network entity 105 or the base station 140 may transmit, to the UE 115, an SFI configuring with a symbol pattern, which may include an SBFD symbol type. That is, the UE 115 may receive a configuration for an SFI table with a set of symbol formats including an SBFD symbol format. Accordingly, the SFI may indicate for the UE 115 to use an SBFD symbol format. Additionally, or alternatively, the UE 115 may be configured with one or more time patterns (e.g., patterns of slots including SBFD symbols), and the SFI may indicate a time pattern of the one or more time patterns for the UE 115 to apply to one or more symbols.

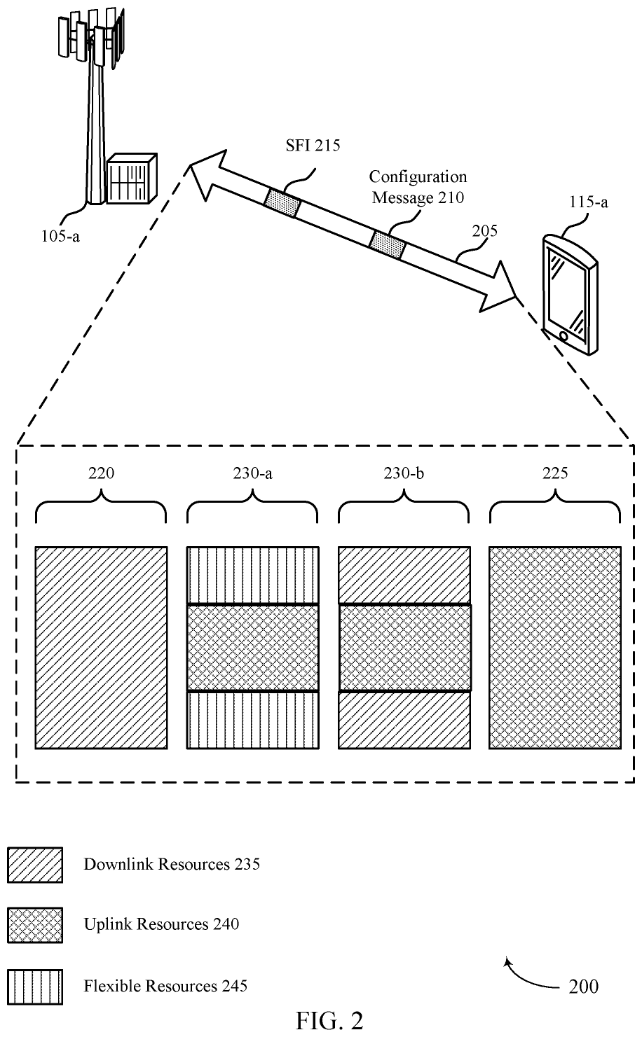

FIG. 2 shows an example of a wireless communications system 200 that supports SBFD symbol information via SFIs in accordance with one or more aspects of the present disclosure. The wireless communications system 200 may implement or may be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described with reference to FIG. 1.

In some examples, the network entity 105-a may configure the UE 115-a with a symbol pattern that designates one or more time resources (e.g., symbols, slots) as TDD uplink resources, TDD downlink resources, and/or TDD flexible resources. For example, the network entity 105-a may transmit a control message (e.g., RRC signaling, MAC-CE signaling, DCI) via a channel 205 between the UE 115-a and the network entity 105-a. The configuration message 210 may include one or more parameters (e.g., tdd-UL-DL-ConfigurationCommon, tdd-ULDL-ConfigurationDedicated) that indicates one or more slots or symbols of a slot as TDD uplink symbols 225 with uplink resources 240, TDD downlink symbols 220 with downlink resources 235, or TDD flexible symbols. The UE 115-a may receive a configuration (e.g., via the control message) that converts one or more of the TDD downlink symbols 220 or the TDD flexible symbols to SBFD symbols 230 with both uplink resources 240 and either downlink resources 235 or flexible resources 245 (e.g., in uplink subbands and downlink and/or flexible subbands, respectively). For example, a TDD flexible symbol that is converted into an SBFD symbol 230-a may include flexible subbands, and a TDD downlink symbol 220 that is converted into an SBFD symbol 230-b may include downlink subbands.

In some cases, the UE 115-a may perform communications in the SBFD symbol 230-a that is configured in a TDD flexible symbol (e.g., a symbol configured as flexible via tdd-UL-DL-ConfigCommon or tdd-ULDL-ConfigurationDedicated and reconfigured as the SBFD symbol 230-a). For example, the UE 115-a may handle the flexible subbands as downlink resources 235. In such examples, the UE 115-a may transmit uplink communication via an uplink subband in the SBFD symbol 230-a (e.g., and may not transmit (e.g., refrain from) uplink communication outside of the uplink subband). Put another way, uplink transmission within an uplink subband may be allowed in the SBFD symbol 230-a, and uplink transmission outside the uplink subband may not be allowed in the SBFD symbol 230-a. The UE 115-a may receive downlink communication via the flexible subbands in the SBFD symbol 230-a (e.g., the subbands that the UE 115-a handles as downlink resources 235). The UE 115-a may receive downlink communication outside of the flexible subbands in the SBFD symbol 230-a.

Additionally, or alternatively, the UE 115-a may handle the flexible subbands in the SBFD symbol 230-b as flexible, and may use resource blocks (RBs) in the flexible subbands (e.g., outside of the uplink subband) as either uplink resources 240 or downlink resources 235 (e.g., excluding one or more guard bands between the uplink subband and the flexible subbands). Each of the flexible subbands may be associated with a same transmission direction (e.g., uplink or downlink). In such examples, the UE 115-a may transmit uplink communication via the SBFD symbol 230-b in either or both of the uplink subband and the flexible subbands. The UE 115-a may receive downlink communication via the flexible subbands in the SBFD symbol 230-a (e.g., the subbands that the UE 115-a handles as downlink resources 235). The UE 115-a may receive downlink communication outside of the flexible subbands in the SBFD symbol 230-a. That is, in some examples, the UE 115-a may convert the SBFD symbol 230-a to a downlink dedicated symbol without one or more uplink subbands.

The network entity 105-a may transmit a DCI message (e.g., a DCI with format 2_0). The DCI may include a SFI 215 (e.g., in an SFI-index field of the DCI), which may assign one or more of the time resources (e.g., TDD flexible symbols) as a downlink symbol, an uplink symbol, or a flexible symbol. The UE 115-a may not expect (e.g., monitor) to receive a DCI (e.g., a DCI with format 2_0) with an SFI-index field value indicating a symbol format (e.g., uplink, downlink, or flexible) for one or more symbols configured as uplink or downlink by the one or more parameters (e.g., tdd-UL-DL-ConfigurationCommon, tdd-ULDL-ConfigurationDedicated), or for one or more symbols (e.g., TDD downlink symbols or TDD flexible symbols) that are converted to SBFD symbols.

In the example of FIG. 2, the network entity 105-a transmits an SFI 215 (e.g., an enhanced SFI 215) that may indicate a functionality of SBFD symbols 230 (e.g., downlink symbols or flexible symbols with an uplink subband). For example, the UE 115-a (e.g., a half-duplex capable SBFD-aware UE 115-a) may use the enhanced SFI 215 to determine a traffic direction (e.g., uplink or downlink) of the SBFD symbols 230. That is, the enhanced SFI 215 may indicate for the UE 115-a to transmit uplink communication via the uplink subband of the SBFD symbol 230 or to receive downlink communication via the downlink or flexible subbands of the SBFD symbol 230. Additionally, or alternatively, the enhanced SFI 215 may enable the UE 115-a to dynamically fall back (e.g., revert) to a TDD slot format. For example, the network entity 105-a may determine to convert an SBFD symbol 230 to a TDD uplink symbol 225, a TDD downlink symbol 220, and/or a TDD flexible symbol.

In some aspects, for one or more SBFD symbols 230-b that are configured in TDD downlink symbols 220, the enhanced SFI 215 may indicate for the UE 115-a to use the SBFD symbols 230-b as downlink resources 235 (e.g., with an SFI-index field value indicating downlink). The UE 115-a may accordingly receive downlink communication via the downlink subbands of the SBFD symbols 230-b. The downlink communication may include a PDSCH transmission, a PDCCH transmission, a CSI-RS, or a PRS (e.g., downlink transmission configured by higher-layer or triggered by a DCI).

Additionally, or alternatively, the enhanced SFI 215 may indicate for the UE 115-a to use the SBFD symbols 230-b as uplink resources 240 (e.g., with an SFI-index field value indicating uplink). The UE 115-a may accordingly transmit uplink communication via the uplink subband in the SBFD symbols 230-b. The uplink communication may include a physical uplink shared channel (PUCCH) transmission, a physical uplink shared channel (PUSCH) transmission, a sounding reference signal (SRS), and/or a physical random access channel (PRACH) transmission.

Additionally, or alternatively, the enhanced SFI 215 may indicate for the UE 115-a to use the SBFD symbols 230-b as flexible resources (e.g., with an SFI-index field value indicating flexible). In some examples, the UE 115-a may monitor for a DCI message scheduling either uplink or downlink communication via the SBFD symbol 230-b in response to the enhanced SFI 215 indicating for the UE 115-a to use the SBFD symbols 230-b as flexible resources. The UE 115-a may accordingly transmit uplink communication or receive downlink communication via the SBFD symbols 230-b in a direction determined by the scheduling DCI. In some examples, if the UE 115-a receives a scheduling DCI scheduling an uplink transmission, the UE 115-a may drop reception (e.g., higher layer configured reception of downlink messages) in the downlink subbands and may transmit the scheduled uplink communication via the uplink subbands. In some examples, if the UE 115-a receives a scheduling DCI scheduling a downlink transmission, the UE 115-a may cancel transmission (e.g., higher layer configured transmission of uplink messages) in the uplink subbands and may receive the scheduled downlink communication via the downlink subbands.

In some examples, if the enhanced SFI 215 indicates for the UE 115-a to use the SBFD symbols 230-b as flexible resources, the UE 115-a may handle the SBFD symbols 230-b as reserved symbols. That is, the UE 115-a may not transmit or receive communication via the SBFD symbols 230-b. In some examples, the UE 115-a may not expect (e.g., monitor a downlink channel) to receive the enhanced SFI 215 indicating for the UE 115-a to use the SBFD symbols 230-b as flexible resources.

In some aspects, for one or more SBFD symbols 230-a that are configured in TDD flexible symbols, the enhanced SFI 215 may indicate for the UE 115-a to use the SBFD symbols 230-a as downlink resources 235 (e.g., with an SFI-index field value indicating downlink). The UE 115-a may accordingly receive downlink communication via the flexible subbands of the SBFD symbols 230-a. The downlink communication may include a PDSCH transmission, a PDCCH transmission, a CSI-RS, or a PRS (e.g., downlink transmission configured by higher-layer or triggered by a DCI).

Additionally, or alternatively, the enhanced SFI 215 may indicate for the UE 115-a to use the SBFD symbols 230-a as uplink resources 240 (e.g., with an SFI-index field value indicating uplink). The UE 115-a may accordingly transmit uplink communication via the uplink subband in the SBFD symbols 230-a. In some examples, the UE 115-a may transmit uplink communication in the flexible subbands of the SBFD symbols 230-a in addition to or instead of the uplink subband of the SBFD symbols 230-a. The uplink communication may include a PUCCH transmission, a PUSCH transmission, a SRS, and/or a PRACH transmission.

Additionally, or alternatively, the enhanced SFI 215 may indicate for the UE 115-a to use the SBFD symbols 230-a as flexible resources (e.g., with an SFI-index field value indicating flexible). In some examples, the UE 115-a may monitor for a DCI message scheduling either uplink or downlink communication via the SBFD symbol 230-a in response to the enhanced SFI 215 indicating for the UE 115-a to use the SBFD symbols 230-a as flexible resources. The UE 115-a may accordingly transmit uplink communication or receive downlink communication via the SBFD symbols 230-a in a direction determined by the scheduling DCI. In some examples, if the UE 115-a receives a scheduling DCI scheduling an uplink transmission, the UE 115-a may drop reception (e.g., higher layer configured reception of downlink messages) in the flexible subbands and may transmit the scheduled uplink communication via the uplink subbands. In some examples, if the UE 115-a receives a scheduling DCI scheduling a downlink transmission, the UE 115-a may cancel transmission (e.g., higher layer configured transmission of uplink messages) in the uplink subbands and may receive the scheduled downlink communication via the flexible subbands.

In some examples, if the enhanced SFI 215 indicates for the UE 115-a to use the SBFD symbols 230-a as flexible resources, the UE 115-a may handle the flexible subbands of the SBFD symbols 230-a as downlink resources. That is, the UE 115-a may receive downlink communication via the flexible subbands of the SBFD symbols 230-a. The downlink communication may include a PDSCH transmission, a PDCCH transmission, a CSI-RS, or a PRS (e.g., downlink transmission configured by higher-layer or triggered by a DCI).

In some examples, if the enhanced SFI 215 indicates for the UE 115-a to use the SBFD symbols 230-a as flexible resources, the UE 115-a may handle the SBFD symbols 230-a (e.g., or the flexible subbands of the SBFD symbols 230-a) as reserved symbols. That is, the UE 115-a may drop downlink reception and cancel uplink transmission configured by higher layer signaling the SBFD symbols 230-a, and/or the UE 115-a may drop downlink reception configured by higher layer signaling in the flexible subbands (e.g., and may transmit uplink via the uplink subband). In some examples, the UE 115-a may not expect to receive the enhanced SFI 215 indicating for the UE 115-a to use the SBFD symbols 230-a as flexible resources.

In some aspects, the UE 115-a may monitor for the DCI carrying the enhanced SFI 215. In examples in which the UE 115-a does not (e.g., fails to) detect the DCI (e.g., DCI format 2_0) carrying the enhances SFI 215, the UE 115-a may handle the SBFD symbols 230-a and the SBFD symbols 230-b as flexible symbols. That is, the UE 115-a may use the SBFD symbols 230-a and the SBFD symbols 230-b as though the UE 115-a received the SFI 215 with an SFI-index value indicating downlink. Accordingly, the UE 115-a may handle the SBFD symbols 230-a and/or the SBFD symbols 230-b as downlink symbols, as uplink symbols, as symbols with a direction determined via a scheduling DCI, and/or as reserved symbols (e.g., or reserved subbands within the symbols) as described herein with reference to an SFI 215 indicating for the UE 115-a one or more SBFD symbols 230-a and/or SBFD symbols 230-b as flexible.

In some aspects, the enhanced SFI 215 may indicate for the UE 115-a to fall back to a TDD symbol format or configuration (e.g., to reconvert the converted SBFD symbols 230 to TDD flexible symbols, TDD downlink symbols 220, and/or TDD uplink symbols 225). For example, for one or more SBFD symbols 230-b that are configured in TDD downlink symbols 220, the enhanced SFI 215 may indicate for the UE 115-a to use the SBFD symbols 230-b as downlink resources 235 (e.g., with an SFI-index field value indicating downlink). The UE 115-a may accordingly receive downlink communication via the SBFD symbols 230-b according to a TDD downlink symbol 220 configuration (e.g., via any frequency band of the SBFD symbols 230-b). The downlink communication may include a PDSCH transmission, a PDCCH transmission, a CSI-RS, or a PRS (e.g., downlink transmission configured by higher-layer or triggered by a DCI).

Additionally, or alternatively, the enhanced SFI 215 may indicate for the UE 115-a to use the SBFD symbols 230-b as uplink resources 240 (e.g., with an SFI-index field value indicating uplink). The UE 115-a may not expect to receive the enhanced SFI 215 with an SFI-index value indicating uplink (e.g., as SBFD symbols 230 may be configured in TDD downlink symbols 220 or TDD flexible symbols, but not TDD uplink symbols 225). Accordingly, the UE 115-a may handle the SFI 215 with the SFI-index value indicating uplink as an error case, and may declare an error associated with receiving the SFI 215.

Additionally, or alternatively, the enhanced SFI 215 may indicate for the UE 115-a to use the SBFD symbols 230-b as flexible resources (e.g., with an SFI-index field value indicating flexible). The UE 115-a may not expect to receive the enhanced SFI 215 with an SFI-index value indicating flexible. Accordingly, the UE 115-a may handle the SFI 215 with the SFI-index value indicating flexible as an error case, and may declare an error associated with receiving the SFI 215.

In some examples, if the enhanced SFI 215 indicates for the UE 115-a to use the SBFD symbols 230-a as flexible resources, the UE 115-a may fall back to a TDD flexible symbol configuration. That is, the UE 115-a may monitor for a DCI indicating for the UE 115-a to use the SBFD symbols 230-a as TDD downlink symbols 220 or TDD uplink symbols 225.

In some aspects, for one or more SBFD symbols 230-a that are configured in TDD flexible symbols, the enhanced SFI 215 may indicate for the UE 115-a to use the SBFD symbols 230-a as downlink resources 235 (e.g., with an SFI-index field value indicating downlink). The UE 115-a may accordingly receive downlink communication via the SBFD symbols 230-a according to a TDD downlink symbol 220 configuration (e.g., via any frequency band of the SBFD symbols 230-a). The downlink communication may include a PDSCH transmission, a PDCCH transmission, a CSI-RS, or a PRS (e.g., downlink transmission configured by higher-layer or triggered by a DCI).

Additionally, or alternatively, the enhanced SFI 215 may indicate for the UE 115-a to use the SBFD symbols 230-a as uplink resources 240 (e.g., with an SFI-index field value indicating uplink). The UE 115-a may not expect (e.g., monitor a downlink channel) to receive the enhanced SFI 215 with an SFI-index value indicating uplink (e.g., as SBFD symbols 230 may be configured in TDD downlink symbols 220 or TDD flexible symbols, but not TDD uplink symbols 225). Accordingly, the UE 115-a may handle the SFI 215 with the SFI-index value indicating uplink as an error case, and may declare an error associated with receiving the SFI 215.

In some examples, if the enhanced SFI 215 indicates for the UE 115-a to use the SBFD symbols 230-a as uplink resources, the UE 115-a may fall back to a TDD uplink symbol configuration. The UE 115-a may accordingly transmit uplink communication via the SBFD symbols 230-a according to a TDD uplink symbol 225 configuration (e.g., via any frequency band of the SBFD symbols 230-a). The uplink communication may include a PUCCH transmission, a PUSCH transmission, a SRS, and/or a PRACH transmission.

Additionally, or alternatively, the enhanced SFI 215 may indicate for the UE 115-a to use the SBFD symbols 230-a as flexible resources (e.g., with an SFI-index field value indicating flexible). In such examples, the UE 115-a may fall back to a TDD flexible symbol configuration. That is, the UE 115-a may monitor for a DCI indicating for the UE 115-a to use the SBFD symbols 230-a as TDD downlink symbols 220 or TDD uplink symbols 225.

In some aspects, the enhanced SFI 215 may dynamically indicate for the UE 115-a to use a set of symbols of a slot (e.g., one or more TDD flexible symbols or TDD downlink symbols 220 configured as flexible or downlink via tdd-UP-DL-ConfigurationCommon and/or tdd-ULDL-ConfigurationDedicated in the configuration message 210) as SBFD symbols 230. For example, the SFI may indicate a symbol type of U, D, or X, indicating for the UE 115-a to use a TDD flexible symbol as an uplink symbol 225, a downlink symbol 220, or an SBFD symbol 230, respectively.

In some aspects, the UE 115-a may receive control signaling (e.g., the configuration message 210, RRC signaling, MAC-CE signaling, DCI signaling) indicating an SFI table with configurations for multiple SBFD symbol time patterns (e.g., patterns of SBFD symbols 230, flexible symbols, downlink symbols 220, and/or uplink symbols 225 in a slot). The SFI table may include one or more entries indicating a slot format for one or more SBFD symbols 230 (e.g., X). An example SFI table is illustrated below with reference to Table 1.

TABLE 1

Symbol number in a slot

| Format | 0 | 1 | 2 | 3 | . . . | 13 |
|---|---|---|---|---|---|---|
| 0 | D | D | D | D | . . . | D |
| 1 | U | U | U | U | . . . | U |
| 2 | F | F | F | F | . . . | F |

. . .

| | | | | | | |
|---|---|---|---|---|---|---|
| 56 | D | D | F | X | . . . | U |
| 57 | X | X | X | X | . . . | X |

. . .

Table 1 is an illustrative example. In some examples, the SFI table may include one or more additional or fewer entries than illustrated with reference to Table 1. In some examples, the entries of the SFI table may be different than those illustrated with reference to Table 1. For example, the SFI table may include a different value (e.g., other than X) to represent SFBD symbols 230, or a different format index (e.g., other than 56 or 57) to represent time patterns with SBFD symbols 230. Additionally, or alternatively, the SFI table may include a different order of slot or symbol formats than the example order shown.

A bitfield of the SFI 215 (e.g., the SFI-index field in the DCI format 2_0) may indicate a value of the SFI table indicating for the UE 115-a to use one or more symbols as SBFD symbols 230 (e.g., as illustrated with reference to example slot formats 56 and 57). The UE 115-a may accordingly configure the symbols indicated by the SFI table to be SBFD symbols (e.g., with a symbol type X) with uplink subbands and flexible or downlink subbands, as illustrated with reference to the SBFD symbol 230-a and the SBFD symbol 230-b. In some examples, the SFI table may indicate for the UE 115-a to use a slot as an SBFD-only slot (e.g., as illustrated with reference to format 57), or as a combination of uplink, downlink, flexible, and SFBD slots (e.g., as illustrated with reference to format 56). In some examples, the SFI table may include a first symbol type (e.g., X) for SBFD symbols 230-a with flexible subbands, and a second symbol type (e.g., Y) for SBFD symbols 230-b with downlink subbands.

In some examples, the UE 115-a may use an SBFD symbol pattern indicated by the SFI 215 for a duration (e.g., a set of slots or symbols indicated by the SFI 215). That is, SBFD symbol pattern switching may be applicable to an indicated set of symbols. In some examples, the UE 115-a may use an SBFD symbol pattern indicated by the SFI 215 until the UE 115-a receives an SFI 215 indicating for the UE 115-a to use a different SBFD symbol pattern. Put another way, the SBFD symbol pattern may be “sticky” or “static” until the UE 115-a receives an SBFDM symbol pattern switching indication.

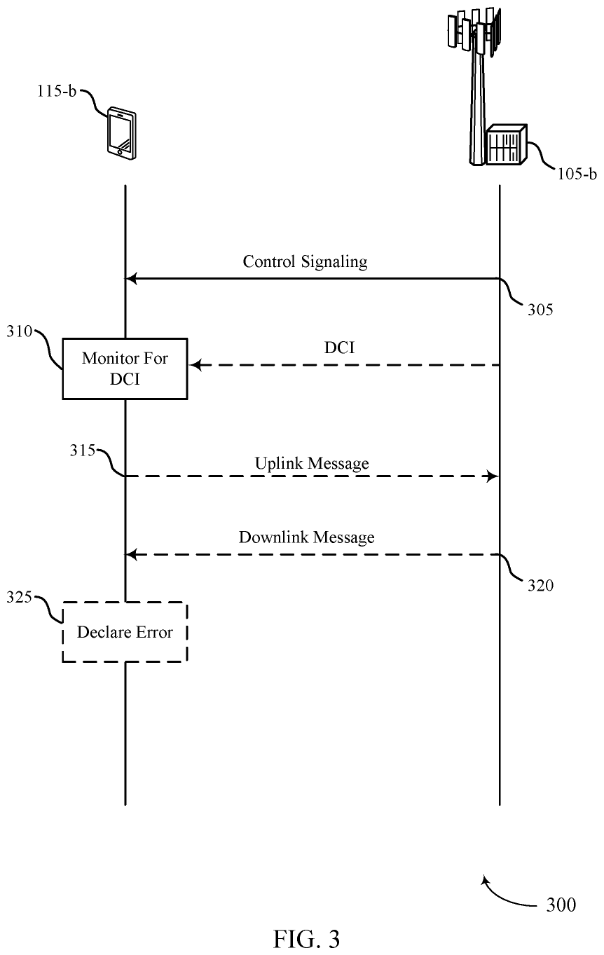

FIG. 3 shows an example of a process flow 300 that supports SBFD symbol information via SFIs in accordance with one or more aspects of the present disclosure. The process flow 300 may implement or may be implemented by aspects of the wireless communications system 100 or the wireless communications system 200. For example, the process flow 300 may include a UE 115 (e.g., a UE 115-b) and a network entity 105 (e.g., a network entity 105-b), which may be examples of the corresponding devices as described with reference to FIG. 1.

In the following description of the process flow 300, the operations between the UE 115-b and the network entity 105-b may be transmitted in a different order than the example order shown. Some operations may also be omitted from the process flow 400, and other operations may be added to the process flow 300. Further, although some operations or signaling may be shown to occur at different times for discussion purposes, these operations may actually occur at the same time.

In some examples, at 305, the UE 115-b may receive control signaling from the network entity 105-b. For example, the control signaling may include one or more RRC messages, DCI messages, or MAC-CE messages. The UE 115-b may receive the control signaling via a PDCCH or a PDSCH.

In some examples, the control signaling may indicate a configuration of a set of one or more SBFD symbols configured in one or more TDD downlink symbols or TDD flexible symbols. That is, the set of one or more SBFD symbols may be configured in the one or more TDD downlink symbols or the one or more TDD flexible symbols by converting the one or more TDD downlink symbols or the one or more TDD flexible symbols to SBFD symbols.

At 310, the UE 115-b may monitor for a DCI message from the network entity 105-b including an SFI. The SFI may indicate for the UE 115-b to use each of one or more SBFD symbols of the set of one or more SBFD symbols as downlink symbols, uplink symbols, or flexible symbols. The UE 115-b may receive the DCI via the PDCCH or the PDSCH. In some examples, the UE 115-b may not receive the DCI message including the SFI. The UE 115-b may perform wireless communication according to the configuration, the SFI, or both, as described with reference to 315 through 325. In some examples, the UE 115-b may refrain from receiving a downlink communication or transmitting an uplink communication via one or more SBFD symbols indicated as flexible by the SFI. In some examples, if the UE 115-b does not receive the DCI, the UE 115-b may determine to use the set of one or more SBFD symbols as TDD flexible symbols.

In some examples, at 315, the UE 115-b may transmit one or more uplink messages to the network entity 105-b via a PUSCH or a PUCCH. For example, if the SFI indicates that one or more SBFD symbols configured in one or more TDD downlink symbols or TDD flexible symbols are to be used as uplink symbols, the UE 115-b may transmit the one or more uplink messages. Additionally, or alternatively, if the SFI indicates that one or more SBFD symbols configured in one or more TDD flexible symbols are to be used as flexible symbols, the UE 115-b may transmit the one or more uplink messages.

The UE 115-b may transmit the one or more uplink messages via uplink subbands in the one or more SBFD symbols (e.g., according to an SBFD configuration). Additionally, or alternatively, the UE 115-b may transmit the one or more uplink messages according to a TDD uplink configuration and/or a TDD flexible configuration (e.g., in accordance with or irrespective of the SFI).

In some examples, the uplink messages may include one or more of a PUCCH transmission, a PUSCH transmission, an SRS transmission, or a PRACH transmission (e.g., configured by higher-layer signaling). The UE 115-b may refrain from receiving downlink messages via one or more downlink subbands of the one or more SBFD symbols (e.g., if the SFI indicates the SBFD symbols as flexible). For example, the UE 115-b may cancel or drop reception of one or more downlink messages.

In some examples, at 320, the UE 115-b may receive one or more downlink messages from the network entity 105-b via a PDSCH or a PDCCH. For example, if the SFI indicates that one or more SBFD symbols configured in one or more TDD downlink symbols or one or more TDD flexible symbols are to be used as downlink symbols, the UE 115-b may receive the one or more downlink messages. Additionally, or alternatively, if the SFI indicates that one or more SBFD symbols configured in one or more TDD flexible symbols are to be used as flexible symbols, the UE 115-b may receive the one or more downlink messages.

The UE 115-b may receive the one or more downlink messages via downlink or flexible subbands in the one or more SBFD symbols (e.g., according to an SBFD configuration). Additionally, or alternatively, the UE 115-b may receive the one or more downlink messages according to a TDD downlink configuration and/or a TDD flexible configuration.

In some examples, the downlink messages may include one or more of a PDCCH transmission, a PDSCH transmission, a CSI-RS transmission, or a PRS transmission. The UE 115-b may refrain from transmitting uplink messages via one or more uplink subbands of the one or more SBFD symbols (e.g., if the SFI indicates the SBFD symbols as flexible). For example, the UE 115-b may cancel or drop transmission of one or more uplink messages.

In some examples, at 325, the UE 115-b may declare an error associated with configuring the one or more SBFD symbols of the set of one or more SBFD symbols. For example, the UE 115-b may declare an error if the set of SBFD symbols are configured in one or more TDD downlink or TDD flexible symbols, and the SFI indicates for the UE 115-b to use the one or more symbols as uplink.

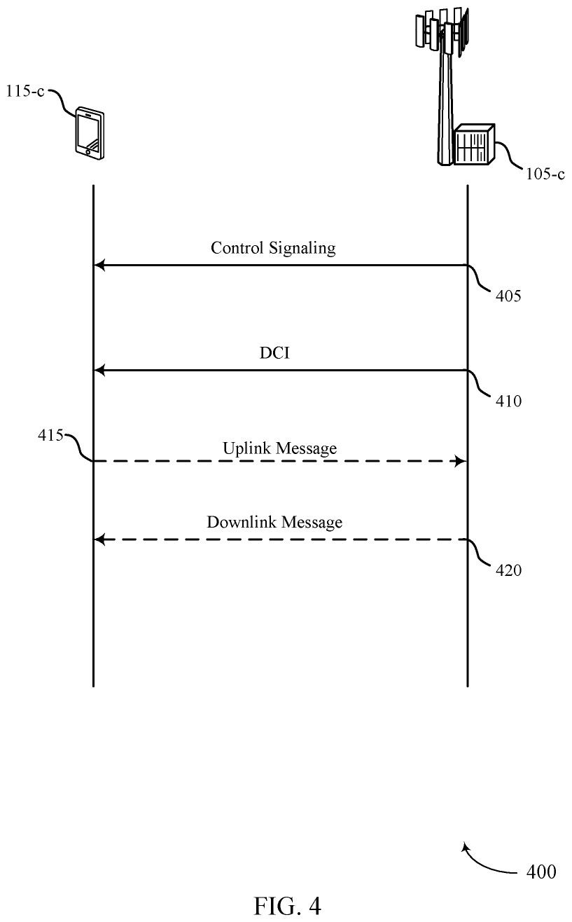

FIG. 4 shows an example of a process flow 400 that supports SBFD symbol information via SFIs in accordance with one or more aspects of the present disclosure. The process flow 400 may implement or may be implemented by aspects of the wireless communications system 100, the wireless communications system 200, or the process flow 300. For example, the process flow 400 may include a UE 115 (e.g., a UE 115-c) and a network entities 105 (e.g., a network entity 105-c), which may be examples of the corresponding devices as described with reference to FIG. 1.

In the following description of the process flow 400, the operations between the UE 115-c and the network entity 105-c may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-c may receive control signaling (e.g., RRC signaling, MAC-CE signaling, DCI) from the network entity 105-c that indicates a configuration for a set of one or more symbols (e.g., symbols of a slot). The UE 115-c may receive the control signaling via a PDCCH or a PDSCH. The configuration may indicate for the UE 115-c to use one or more symbols of the slot as downlink symbols or flexible symbols.

In some examples, the control signaling may include an RRC configuration of a set of SBFD time patterns (e.g., an SFI table of symbol patterns for one or more slots), including one or more symbol patterns indicating for the UE 115-c to use one or more symbols as SBFD symbols. For example, the SFI table may include one or more entries indicating the set of one or more symbols as uplink, downlink, flexible, or SBFD symbols.

At 410, the UE 115-c may receive a DCI (e.g., via a PDCCH or a PDSCH) from the network entity 105-c. The DCI may include one or more SFIs indicating for the UE 115-c to use one or more symbols as TDD downlink symbols, TDD flexible symbols, TDD uplink symbols, or SBFD symbols. In some examples, the SFI may indicate an entry in the SFI table. That is, the SFI may include a bitfield that enables an SBFD symbol pattern from the set of SBFD time patterns for the UE 115-c to apply to one or more slots.

In some examples, the enabled SBFD symbol pattern may be applicable to one or more symbols (e.g., a quantity of symbols indicated via the SFI). In some examples, the SBFD symbol pattern may be applicable until the UE 115-a receives another SFI from the network entity 105-c (e.g., another DCI) indicating a different SBFD symbol pattern from the set of SBFD time patterns.

The UE 115-c may perform wireless communication in accordance with the configuration and/or the SFI. For example, at 415, the UE 115-c may transmit uplink signaling via one or more uplink subbands in an SBFD symbol indicated by the SFI. At 420, the UE 115-c may receive downlink signaling via one or more downlink or flexible subbands in an SBFD symbol indicated by the SFI.

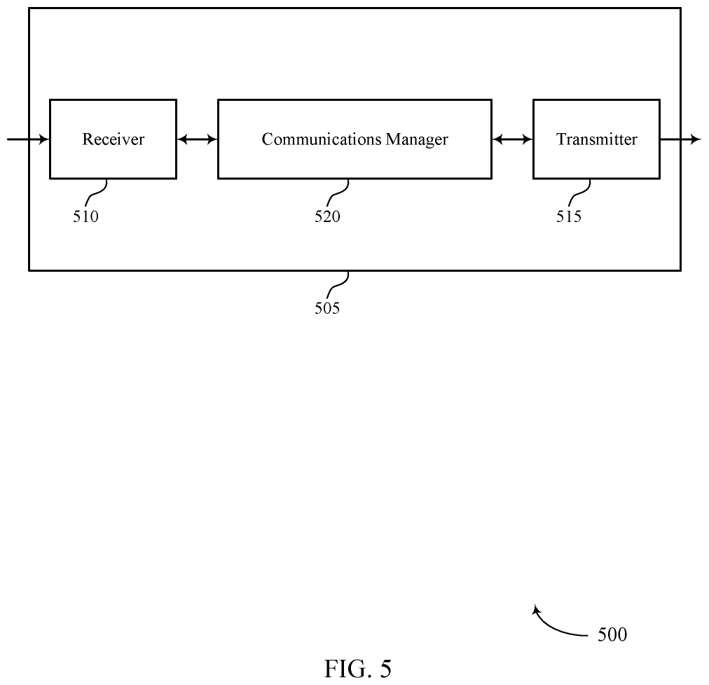

FIG. 5 shows a block diagram 500 of a device 505 that supports SBFD symbol information via SFIs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SBFD symbol information via SFIs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SBFD symbol information via SFIs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of SBFD symbol information via SFIs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling that indicates a configuration including a set of one or more SBFD symbols, where the set of one or more SBFD symbols are configured in one or more TDD downlink symbols or one or more TDD flexible symbols. The communications manager 520 is capable of, configured to, or operable to support a means for monitoring for a DCI including a SFI, where the SFI indicates each of one or more SBFD symbols of the set of one or more SBFD symbols as downlink, uplink, or flexible. The communications manager 520 is capable of, configured to, or operable to support a means for performing wireless communication according to one or more of the configuration or the SFI.

Additionally, or alternatively, the communications manager 520 may support wireless communications in accordance with examples as disclosed herein. For example, the communications manager 520 is capable of, configured to, or operable to support a means for receiving control signaling that indicates a configuration including a set of one or more symbols, where the configuration indicates one or more symbols of the set of one or more symbols as downlink or flexible. The communications manager 520 is capable of, configured to, or operable to support a means for receiving DCI including a SFI, where the SFI indicates each of one or more symbols of the set of one or more symbols as TDD downlink symbols, TDD flexible symbols, or SBFD symbols. The communications manager 520 is capable of, configured to, or operable to support a means for performing wireless communication according to one or more of the configuration or the SFI.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for indicating SBFD information via SFIs, which may enable more efficient utilization of communication resources.

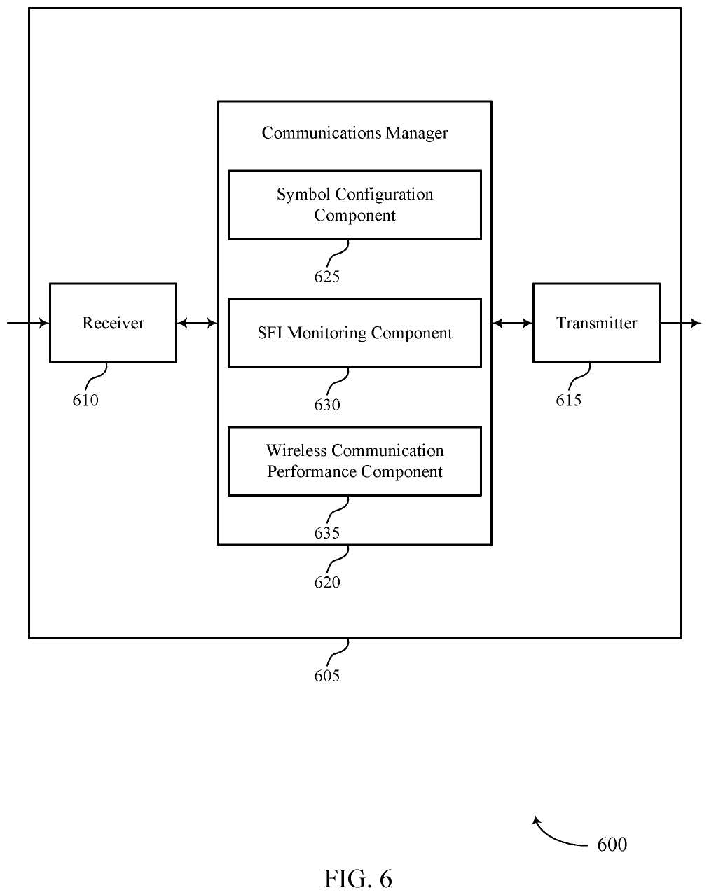

FIG. 6 shows a block diagram 600 of a device 605 that supports SBFD symbol information via SFIs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SBFD symbol information via SFIs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SBFD symbol information via SFIs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SBFD symbol information via SFIs as described herein. For example, the communications manager 620 may include a symbol configuration component 625, an SFI monitoring component 630, a wireless communication performance component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The symbol configuration component 625 is capable of, configured to, or operable to support a means for receiving control signaling that indicates a configuration including a set of one or more SBFD symbols, where the set of one or more SBFD symbols are configured in one or more TDD downlink symbols or one or more TDD flexible symbols. The SFI monitoring component 630 is capable of, configured to, or operable to support a means for monitoring for a DCI including a SFI, where the SFI indicates each of one or more SBFD symbols of the set of one or more SBFD symbols as downlink, uplink, or flexible. The wireless communication performance component 635 is capable of, configured to, or operable to support a means for performing wireless communication according to one or more of the configuration or the SFI.

Additionally, or alternatively, the communications manager 620 may support wireless communications in accordance with examples as disclosed herein. The symbol configuration component 625 is capable of, configured to, or operable to support a means for receiving control signaling that indicates a configuration including a set of one or more symbols, where the configuration indicates one or more symbols of the set of one or more symbols as downlink or flexible. The SFI monitoring component 630 is capable of, configured to, or operable to support a means for receiving DCI including a SFI, where the SFI indicates each of one or more symbols of the set of one or more symbols as TDD downlink symbols, TDD flexible symbols, or SBFD symbols. The wireless communication performance component 635 is capable of, configured to, or operable to support a means for performing wireless communication according to one or more of the configuration or the SFI.

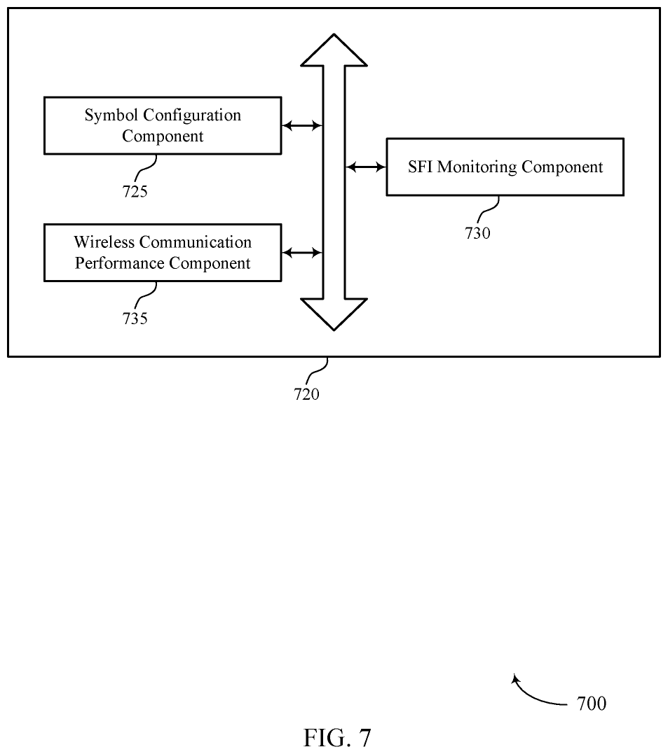

FIG. 7 shows a block diagram 700 of a communications manager 720 that supports SBFD symbol information via SFIs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SBFD symbol information via SFIs as described herein. For example, the communications manager 720 may include a symbol configuration component 725, an SFI monitoring component 730, a wireless communication performance component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The symbol configuration component 725 is capable of, configured to, or operable to support a means for receiving control signaling that indicates a configuration including a set of one or more SBFD symbols, where the set of one or more SBFD symbols are configured in one or more TDD downlink symbols or one or more TDD flexible symbols. The SFI monitoring component 730 is capable of, configured to, or operable to support a means for monitoring for a DCI including a SFI, where the SFI indicates each of one or more SBFD symbols of the set of one or more SBFD symbols as downlink, uplink, or flexible. The wireless communication performance component 735 is capable of, configured to, or operable to support a means for performing wireless communication according to one or more of the configuration or the SFI.

In some examples, the set of one or more SBFD symbols are configured in the one or more TDD downlink symbols or the one or more TDD flexible symbols by converting the one or more TDD downlink symbols or the one or more TDD flexible symbols to one or more SBFD symbols.

In some examples, to support performing wireless communication, the wireless communication performance component 735 is capable of, configured to, or operable to support a means for receiving a downlink communication via one or more downlink subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance component 735 is capable of, configured to, or operable to support a means for transmitting an uplink communication via one or more uplink subbands associated with the set of one or more SBFD symbols, where the uplink communication includes one or more of a PUCCH transmission, an PUSCH transmission, an SRS transmission, or a PRACH transmission.

In some examples, to support performing wireless communication, the wireless communication performance component 735 is capable of, configured to, or operable to support a means for receiving a downlink communication or transmitting an uplink communication based on a corresponding DCI, where receiving downlink communication is based on canceling the uplink communication associated with one or more uplink subbands, and where transmitting the uplink communication is based on dropping the downlink communication associated with one or more downlink subbands.

In some examples, the configuration indicates that one or more SBFD symbols of the set of one or more SBFD symbols are configured in the one or more TDD downlink symbols, and the wireless communication performance component 735 is capable of, configured to, or operable to support a means for refraining from receiving a downlink communication or transmitting an uplink communication via the set of one or more SBFD symbols indicated as flexible.

In some examples, to support performing wireless communication, the wireless communication performance component 735 is capable of, configured to, or operable to support a means for receiving a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance component 735 is capable of, configured to, or operable to support a means for receiving a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance component 735 is capable of, configured to, or operable to support a means for transmitting an uplink communication via one or more uplink subbands associated with the set of one or more SBFD symbols, where the uplink communication includes one or more of a PUCCH transmission, an PUSCH transmission, an SRS transmission, or a PRACH transmission configured by higher-layer signaling.

In some examples, to support performing wireless communication, the wireless communication performance component 735 is capable of, configured to, or operable to support a means for transmitting an uplink communication via one or more uplink subbands and one or more flexible subbands associated with the set of one or more SBFD symbols, where the uplink communication includes one or more of a PUCCH transmission, an PUSCH transmission, an SRS transmission, or a PRACH transmission.

In some examples, the SFI monitoring component 730 is capable of, configured to, or operable to support a means for determining an absence of the SFI that indicates each of one or more SBFD symbols of the set of one or more SBFD symbols as flexible.

In some examples, to support performing wireless communication, the wireless communication performance component 735 is capable of, configured to, or operable to support a means for receiving a downlink communication via one or more TDD downlink symbols based on the SFI indicates each of one or more SBFD symbols of the set of one or more SBFD symbols as downlink.

In some examples, to support performing wireless communication, the wireless communication performance component 735 is capable of, configured to, or operable to support a means for performing the wireless communication via the one or more SBFD symbols or one or more TDD flexible symbols.

In some examples, to support performing wireless communication, the wireless communication performance component 735 is capable of, configured to, or operable to support a means for transmitting one or more messages via the one or more SBFD symbols.

In some examples, to support performing wireless communication, the wireless communication performance component 735 is capable of, configured to, or operable to support a means for performing an uplink communication irrespective of the SFI. In some examples, to support performing wireless communication, the wireless communication performance component 735 is capable of, configured to, or operable to support a means for declaring an error associated with configuring the one or more SBFD symbols of the set of one or more SBFD symbols in the one or more TDD flexible symbols or the one or more TDD downlink symbols.

Additionally, or alternatively, the communications manager 720 may support wireless communications in accordance with examples as disclosed herein. In some examples, the symbol configuration component 725 is capable of, configured to, or operable to support a means for receiving control signaling that indicates a configuration including a set of one or more symbols, where the configuration indicates one or more symbols of the set of one or more symbols as downlink or flexible. In some examples, the SFI monitoring component 730 is capable of, configured to, or operable to support a means for receiving DCI including a SFI, where the SFI indicates each of one or more symbols of the set of one or more symbols as TDD downlink symbols, TDD flexible symbols, or SBFD symbols. In some examples, the wireless communication performance component 735 is capable of, configured to, or operable to support a means for performing wireless communication according to one or more of the configuration or the SFI.

In some examples, the configuration includes at least one SFI table including one or more entries indicatives of the set of one or more symbols as one or more of downlink, uplink, flexible, or SBFB.

In some examples, the symbol configuration component 725 is capable of, configured to, or operable to support a means for receiving a radio resource control signaling that indicates a second configuration including a set of one or more SBFD symbol patterns. In some examples, the wireless communication performance component 735 is capable of, configured to, or operable to support a means for performing wireless communication is based on at least one SBFD symbol pattern of the set of one or more SBFD symbol patterns.

In some examples, the SFI includes a bitfield that enables the at least one SBFD symbol pattern of the set of one or more SBFD symbol patterns.

In some examples, the at least one SBFD symbol pattern of the set of one or more SBFD symbol patterns is applicable to one or more symbols associated with the SFI. In some examples, the at least one SBFD symbol pattern is applicable until a second SFI enables at least one second SBFD symbol pattern of the set of one or more SBFD symbol patterns.

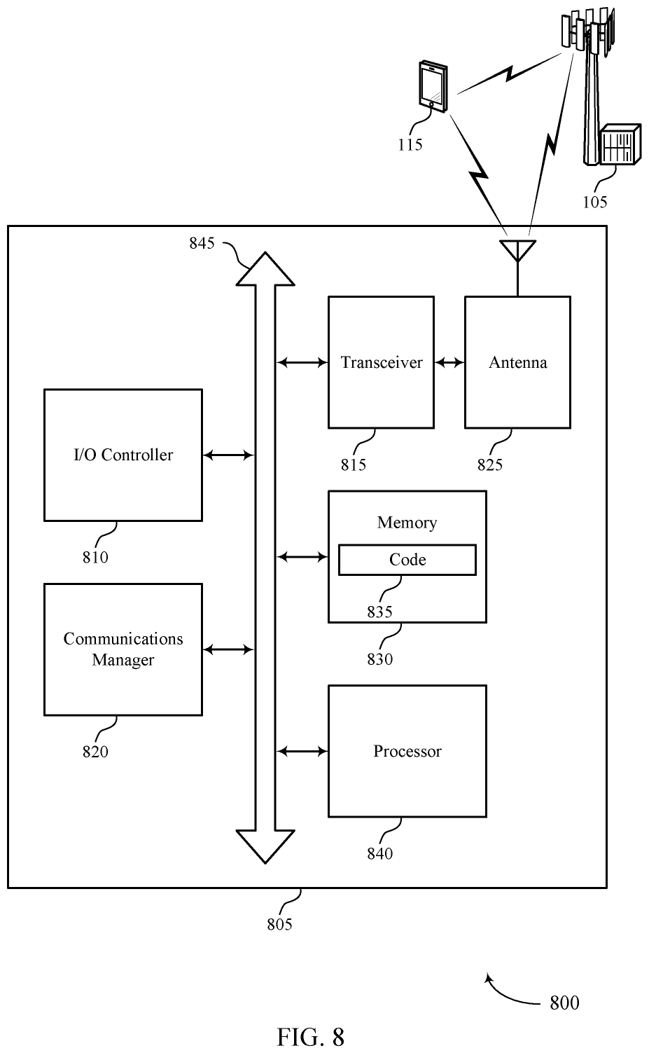

FIG. 8 shows a diagram of a system 800 including a device 805 that supports SBFD symbol information via SFIs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICS, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting SBFD symbol information via SFIs). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling that indicates a configuration including a set of one or more SBFD symbols, where the set of one or more SBFD symbols are configured in the one or more TDD downlink symbols or the one or more TDD flexible symbols. The communications manager 820 is capable of, configured to, or operable to support a means for monitoring for a DCI including a SFI, where the SFI indicates each of one or more SBFD symbols of the set of one or more SBFD symbols as downlink, uplink, or flexible. The communications manager 820 is capable of, configured to, or operable to support a means for performing wireless communication according to one or more of the configuration or the SFI.

Additionally, or alternatively, the communications manager 820 may support wireless communications in accordance with examples as disclosed herein. For example, the communications manager 820 is capable of, configured to, or operable to support a means for receiving control signaling that indicates a configuration including a set of one or more symbols, where the configuration indicates one or more symbols of the set of one or more symbols as downlink or flexible. The communications manager 820 is capable of, configured to, or operable to support a means for receiving DCI including a SFI, where the SFI indicates each of one or more symbols of the set of one or more symbols as TDD downlink symbols, TDD flexible symbols, or SBFD symbols. The communications manager 820 is capable of, configured to, or operable to support a means for performing wireless communication according to one or more of the configuration or the SFI.

By including or configuring the communications manager 820 in accordance with examples as described herein, the device 805 may support techniques for indicating SBFD information via SFIs, which may enable reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of SBFD symbol information via SFIs as described herein, or the at least one processor 840 and the at least one memory 830 may be otherwise configured to, individually or collectively, perform or support such operations.

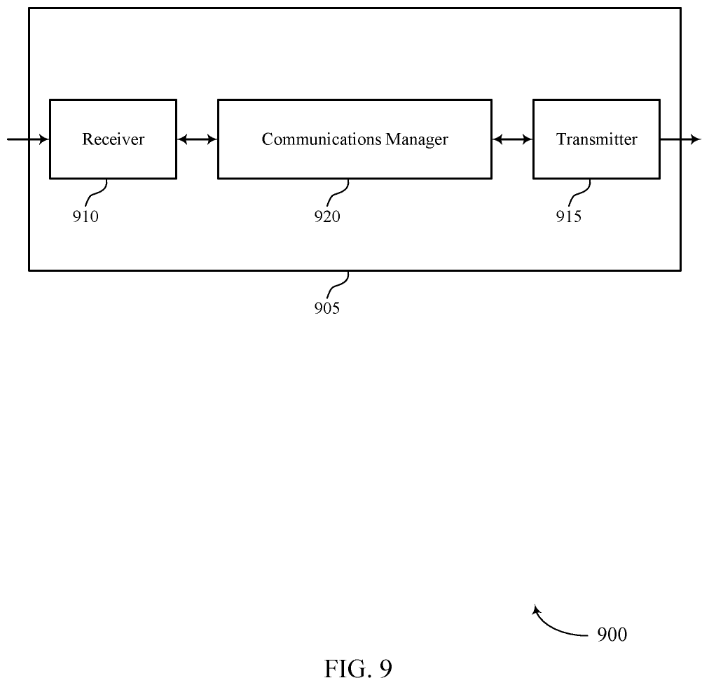

FIG. 9 shows a block diagram 900 of a device 905 that supports SBFD symbol information via SFIs in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of SBFD symbol information via SFIs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling that indicates a configuration including a set of one or more SBFD symbols, where the set of one or more SBFD symbols are configured in the one or more TDD downlink symbols or the one or more TDD flexible symbols. The communications manager 920 is capable of, configured to, or operable to support a means for transmitting a DCI including a SFI, where the SFI indicates each of one or more SBFD symbols of the set of one or more SBFD symbols as downlink, uplink, or flexible. The communications manager 920 is capable of, configured to, or operable to support a means for performing wireless communication according to one or more of the configuration or the SFI.

Additionally, or alternatively, the communications manager 920 may support wireless communications in accordance with examples as disclosed herein. For example, the communications manager 920 is capable of, configured to, or operable to support a means for transmitting control signaling that indicates a configuration including a set of one or more symbols, where the configuration indicates one or more symbols of the set of one or more symbols as downlink or flexible. The communications manager 920 is capable of, configured to, or operable to support a means for transmitting DCI including a SFI, where the SFI indicates each of one or more symbols of the set of one or more symbols as TDD downlink symbols, TDD flexible symbols, or SBFD symbols. The communications manager 920 is capable of, configured to, or operable to support a means for performing wireless communication according to one or more of the configuration or the SFI.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for indicating SBFD information via SFIs, which may enable more efficient utilization of communication resources.

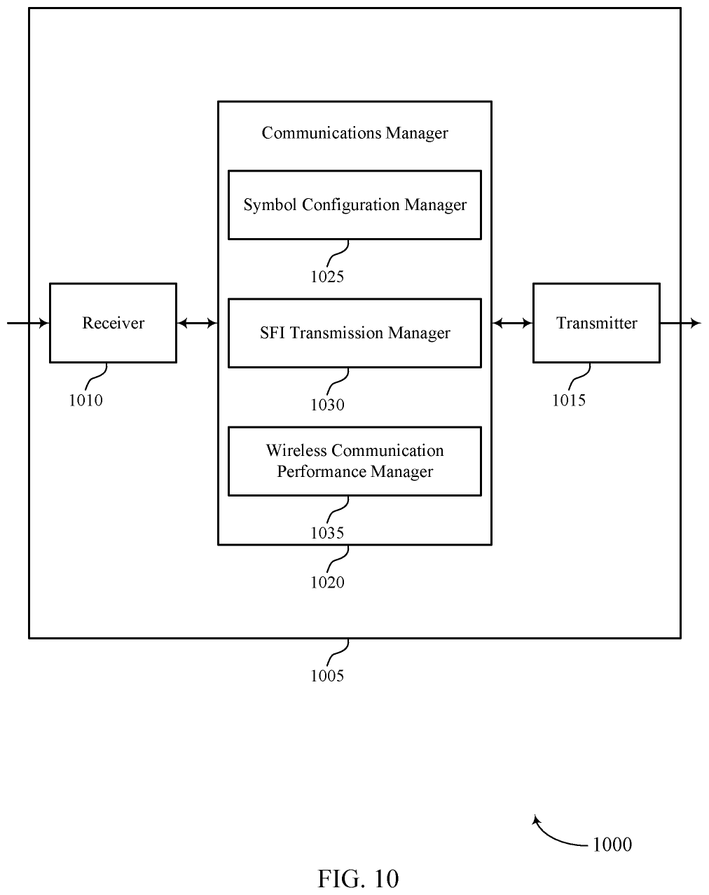

FIG. 10 shows a block diagram 1000 of a device 1005 that supports SBFD symbol information via SFIs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SBFD symbol information via SFIs as described herein. For example, the communications manager 1020 may include a symbol configuration manager 1025, an SFI transmission manager 1030, a wireless communication performance manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The symbol configuration manager 1025 is capable of, configured to, or operable to support a means for transmitting control signaling that indicates a configuration including a set of one or more SBFD symbols, where the set of one or more SBFD symbols are configured in the one or more TDD downlink symbols or the one or more TDD flexible symbols. The SFI transmission manager 1030 is capable of, configured to, or operable to support a means for transmitting a DCI including a SFI, where the SFI indicates each of one or more SBFD symbols of the set of one or more SBFD symbols as downlink, uplink, or flexible. The wireless communication performance manager 1035 is capable of, configured to, or operable to support a means for performing wireless communication according to one or more of the configuration or the SFI.

Additionally, or alternatively, the communications manager 1020 may support wireless communications in accordance with examples as disclosed herein. The symbol configuration manager 1025 is capable of, configured to, or operable to support a means for transmitting control signaling that indicates a configuration including a set of one or more symbols, where the configuration indicates one or more symbols of the set of one or more symbols as downlink or flexible. The SFI transmission manager 1030 is capable of, configured to, or operable to support a means for transmitting DCI including a SFI, where the SFI indicates each of one or more symbols of the set of one or more symbols as TDD downlink symbols, TDD flexible symbols, or SBFD symbols. The wireless communication performance manager 1035 is capable of, configured to, or operable to support a means for performing wireless communication according to one or more of the configuration or the SFI.

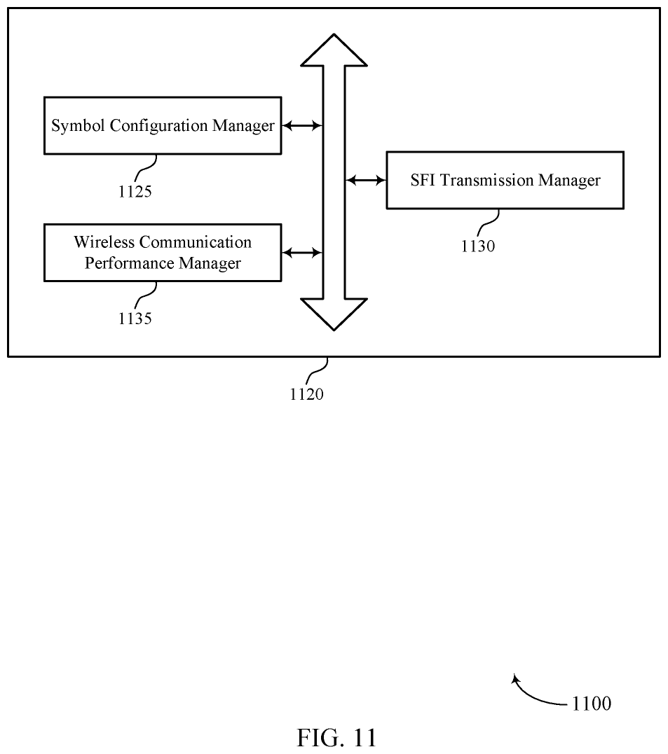

FIG. 11 shows a block diagram 1100 of a communications manager 1120 that supports SBFD symbol information via SFIs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SBFD symbol information via SFIs as described herein. For example, the communications manager 1120 may include a symbol configuration manager 1125, an SFI transmission manager 1130, a wireless communication performance manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The symbol configuration manager 1125 is capable of, configured to, or operable to support a means for transmitting control signaling that indicates a configuration including a set of one or more SBFD symbols, where the set of one or more SBFD symbols are configured in the one or more TDD downlink symbols or the one or more TDD flexible symbols. The SFI transmission manager 1130 is capable of, configured to, or operable to support a means for transmitting a DCI including a SFI, where the SFI indicates each of one or more SBFD symbols of the set of one or more SBFD symbols as downlink, uplink, or flexible. The wireless communication performance manager 1135 is capable of, configured to, or operable to support a means for performing wireless communication according to one or more of the configuration or the SFI.

In some examples, the set of one or more SBFD symbols are configured in the one or more TDD downlink symbols or the one or more TDD flexible symbols by converting the one or more TDD downlink symbols or the one or more TDD flexible symbols to one or more SBFD symbols.

In some examples, to support performing wireless communication, the wireless communication performance manager 1135 is capable of, configured to, or operable to support a means for transmitting a downlink communication via one or more downlink subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance manager 1135 is capable of, configured to, or operable to support a means for receiving an uplink communication via one or more uplink subbands associated with the set of one or more SBFD symbols, where the uplink communication includes one or more of a PUCCH transmission, an PUSCH transmission, an SRS transmission, or a PRACH transmission.

In some examples, to support performing wireless communication, the wireless communication performance manager 1135 is capable of, configured to, or operable to support a means for transmitting a downlink communication or transmitting an uplink communication based on a corresponding DCI, where receiving the downlink communication is based on canceling the uplink communication associated with one or more uplink subbands, and where transmitting the uplink communication is based on dropping the downlink communication associated with one or more downlink subbands.

In some examples, to support performing wireless communication, the wireless communication performance manager 1135 is capable of, configured to, or operable to support a means for transmitting a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance manager 1135 is capable of, configured to, or operable to support a means for transmitting a downlink communication via one or more flexible subbands associated with the set of one or more SBFD symbols, where the downlink communication includes one or more of a PDCCH transmission, an PDSCH transmission, a CSI-RS transmission, or a PRS transmission.

In some examples, to support performing wireless communication, the wireless communication performance manager 1135 is capable of, configured to, or operable to support a means for receiving an uplink communication via one or more uplink subbands associated with the set of one or more SBFD symbols, where the uplink communication includes one or more of a PUCCH transmission, an PUSCH transmission, an SRS transmission, or a PRACH transmission configured by higher-layer signaling.

In some examples, to support performing wireless communication, the wireless communication performance manager 1135 is capable of, configured to, or operable to support a means for receiving an uplink communication via one or more uplink subbands and one or more flexible subbands associated with the set of one or more SBFD symbols, where the uplink communication includes one or more of a PUCCH transmission, an PUSCH transmission, an SRS transmission, or a PRACH transmission.

In some examples, to support performing wireless communication, the wireless communication performance manager 1135 is capable of, configured to, or operable to support a means for transmitting a downlink communication via one or more TDD downlink symbols based on the SFI indicates each of one or more SBFD symbols of the set of one or more SBFD symbols as downlink.

In some examples, to support performing wireless communication, the wireless communication performance manager 1135 is capable of, configured to, or operable to support a means for performing the wireless communication via the one or more SBFD symbols or one or more TDD flexible symbols.

In some examples, to support performing wireless communication, the wireless communication performance manager 1135 is capable of, configured to, or operable to support a means for receiving one or more messages via the one or more SBFD symbols.

In some examples, to support performing wireless communication, the wireless communication performance manager 1135 is capable of, configured to, or operable to support a means for performing an uplink communication irrespective of the SFI.

Additionally, or alternatively, the communications manager 1120 may support wireless communications in accordance with examples as disclosed herein. In some examples, the symbol configuration manager 1125 is capable of, configured to, or operable to support a means for transmitting control signaling that indicates a configuration including a set of one or more symbols, where the configuration indicates one or more symbols of the set of one or more symbols as downlink or flexible. In some examples, the SFI transmission manager 1130 is capable of, configured to, or operable to support a means for transmitting DCI including a SFI, where the SFI indicates each of one or more symbols of the set of one or more symbols as TDD downlink symbols, TDD flexible symbols, or SBFD symbols. In some examples, the wireless communication performance manager 1135 is capable of, configured to, or operable to support a means for performing wireless communication according to one or more of the configuration or the SFI.

In some examples, the configuration includes at least one SFI table including one or more entries indicatives of the set of one or more symbols as one or more of downlink, uplink, flexible, or SBFB.

In some examples, the SFI transmission manager 1130 is capable of, configured to, or operable to support a means for transmitting a radio resource control signaling that indicates a second configuration including a set of one or more SBFD symbol patterns. In some examples, the wireless communication performance manager 1135 is capable of, configured to, or operable to support a means for performing wireless communication is based on at least one SBFD symbol pattern of the set of one or more SBFD symbol patterns.

In some examples, the SFI includes a bitfield that enables the at least one SBFD symbol pattern of the set of one or more SBFD symbol patterns.

In some examples, the at least one SBFD symbol pattern of the set of one or more SBFD symbol patterns is applicable to one or more symbols associated with the SFI. In some examples, the at least one SBFD symbol pattern is applicable until a second SFI enables at least one second SBFD symbol pattern of the set of one or more SBFD symbol patterns.

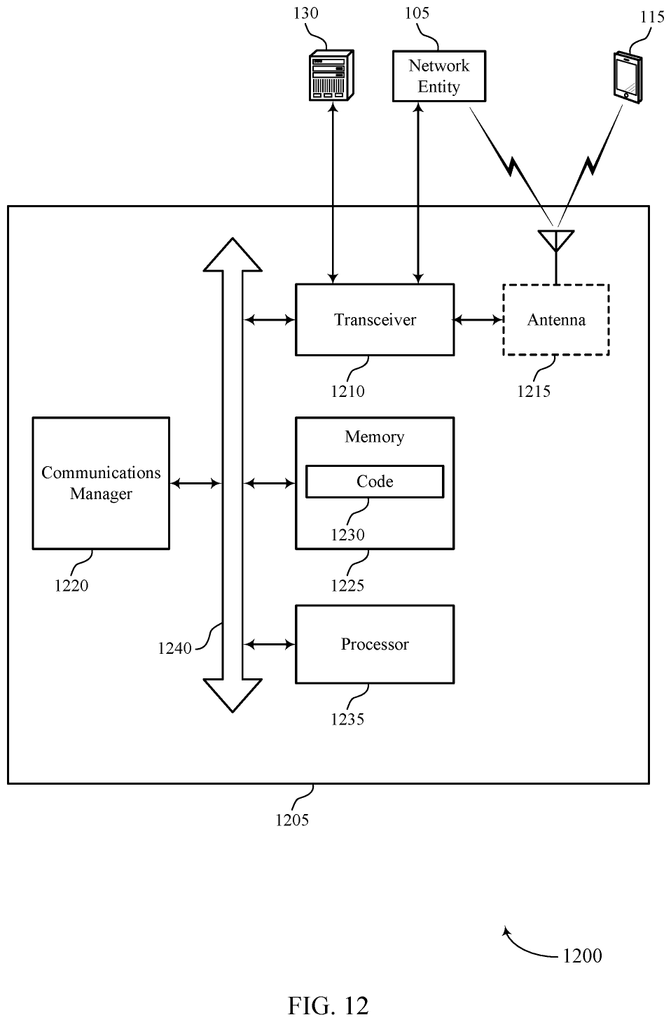

FIG. 12 shows a diagram of a system 1200 including a device 1205 that supports SBFD symbol information via SFIs in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting SBFD symbol information via SFIs). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more Ues 115. In some examples, the communications manager 1220 may manage communications with one or more other network devices 105, and may include a controller or scheduler for controlling communications with Ues 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling that indicates a configuration including a set of one or more SBFD symbols, where the set of one or more SBFD symbols are configured in the one or more TDD downlink symbols or the one or more TDD flexible symbols. The communications manager 1220 is capable of, configured to, or operable to support a means for transmitting a DCI including a SFI, where the SFI indicates each of one or more SBFD symbols of the set of one or more SBFD symbols as downlink, uplink, or flexible. The communications manager 1220 is capable of, configured to, or operable to support a means for performing wireless communication according to one or more of the configuration or the SFI.

Additionally, or alternatively, the communications manager 1220 may support wireless communications in accordance with examples as disclosed herein. For example, the communications manager 1220 is capable of, configured to, or operable to support a means for transmitting control signaling that indicates a configuration including a set of one or more symbols, where the configuration indicates one or more symbols of the set of one or more symbols as downlink or flexible. The communications manager 1220 is capable of, configured to, or operable to support a means for transmitting DCI including a SFI, where the SFI indicates each of one or more symbols of the set of one or more symbols as TDD downlink symbols, TDD flexible symbols, or SBFD symbols. The communications manager 1220 is capable of, configured to, or operable to support a means for performing wireless communication according to one or more of the configuration or the SFI.

By including or configuring the communications manager 1220 in accordance with examples as described herein, the device 1205 may support techniques for indicating SBFD information via SFIs, which may enable reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of SBFD symbol information via SFIs as described herein, or the at least one processor 1235 and the at least one memory 1225 may be otherwise configured to, individually or collectively, perform or support such operations.

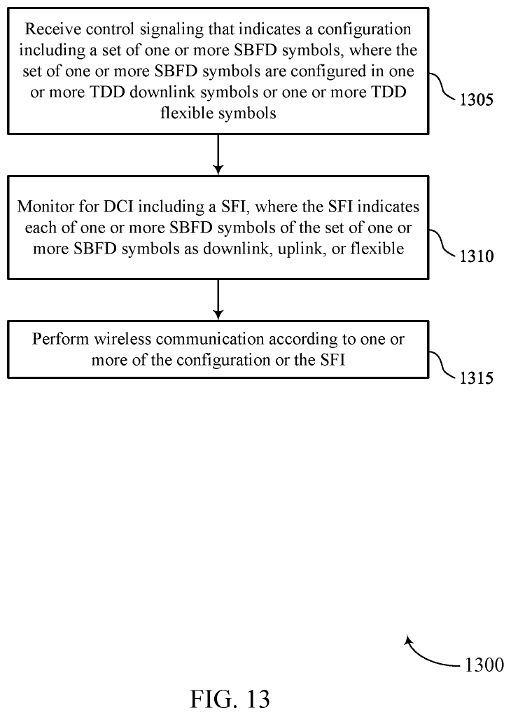

FIG. 13 shows a flowchart illustrating a method 1300 that supports SBFD symbol information via SFIs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates a configuration including a set of one or more SBFD symbols, where the set of one or more SBFD symbols are configured in one or more TDD downlink symbols or one or more TDD flexible symbols. The operations of 1305 may be performed in accordance with examples as disclosed herein. In some examples, aspects of the operations of 1305 may be performed by a symbol configuration component 725 as described with reference to FIG. 7.

At 1310, the method may include monitoring for DCI including a SFI, where the SFI indicates each of one or more SBFD symbols of the set of one or more SBFD symbols as downlink, uplink, or flexible. The operations of 1310 may be performed in accordance with examples as disclosed herein. In some examples, aspects of the operations of 1310 may be performed by an SFI monitoring component 730 as described with reference to FIG. 7.

At 1315, the method may include performing wireless communication according to one or more of the configuration or the SFI. The operations of 1315 may be performed in accordance with examples as disclosed herein. In some examples, aspects of the operations of 1315 may be performed by a wireless communication performance component 735 as described with reference to FIG. 7.

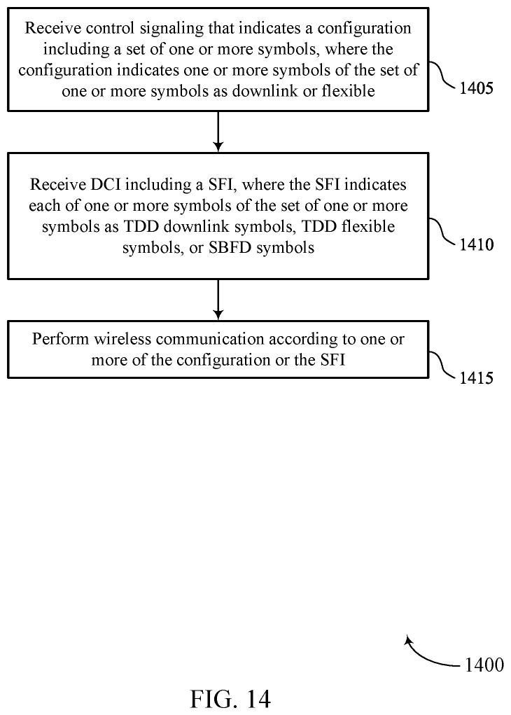

FIG. 14 shows a flowchart illustrating a method 1400 that supports SBFD symbol information via SFIs in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a configuration including a set of one or more symbols, where the configuration indicates one or more symbols of the set of one or more symbols as downlink or flexible. The operations of 1405 may be performed in accordance with examples as disclosed herein. In some examples, aspects of the operations of 1405 may be performed by a symbol configuration component 725 as described with reference to FIG. 7.

At 1410, the method may include receiving DCI including a SFI, where the SFI indicates each of one or more symbols of the set of one or more symbols as TDD downlink symbols, TDD flexible symbols, or SBFD symbols. The operations of 1410 may be performed in accordance with examples as disclosed herein. In some examples, aspects of the operations of 1410 may be performed by an SFI monitoring component 730 as described with reference to FIG. 7.

At 1415, the method may include performing wireless communication according to one or more of the configuration or the SFI. The operations of 1415 may be performed in accordance with examples as disclosed herein. In some examples, aspects of the operations of 1415 may be performed by a wireless communication performance component 735 as described with reference to FIG. 7.

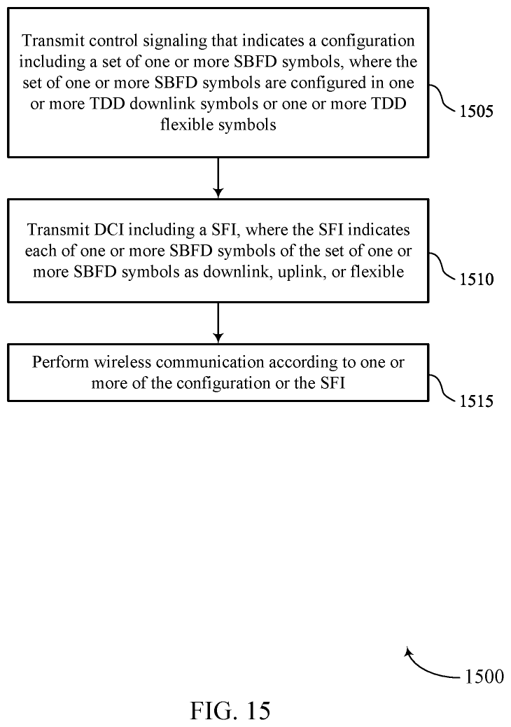

FIG. 15 shows a flowchart illustrating a method 1500 that supports SBFD symbol information via SFIs in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that indicates a configuration including a set of one or more SBFD symbols, where the set of one or more SBFD symbols are configured in one or more TDD downlink symbols or one or more TDD flexible symbols. The operations of 1505 may be performed in accordance with examples as disclosed herein. In some examples, aspects of the operations of 1505 may be performed by a symbol configuration manager 1125 as described with reference to FIG. 11.

At 1510, the method may include transmitting DCI including a SFI, where the SFI indicates each of one or more SBFD symbols of the set of one or more SBFD symbols as downlink, uplink, or flexible. The operations of 1510 may be performed in accordance with examples as disclosed herein. In some examples, aspects of the operations of 1510 may be performed by an SFI transmission manager 1130 as described with reference to FIG. 11.

At 1515, the method may include performing wireless communication according to one or more of the configuration or the SFI. The operations of 1515 may be performed in accordance with examples as disclosed herein. In some examples, aspects of the operations of 1515 may be performed by a wireless communication performance manager 1135 as described with reference to FIG. 11.

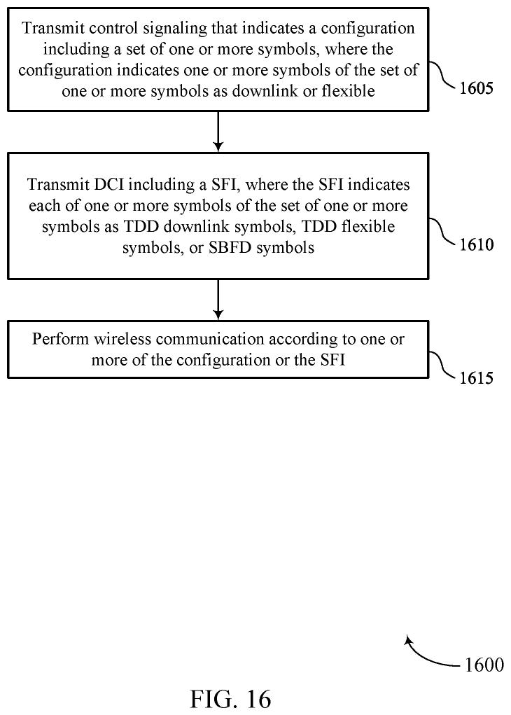

FIG. 16 shows a flowchart illustrating a method 1600 that supports SBFD symbol information via SFIs in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling that indicates a configuration including a set of one or more symbols, where the configuration indicates one or more symbols of the set of one or more symbols as downlink or flexible. The operations of 1605 may be performed in accordance with examples as disclosed herein. In some examples, aspects of the operations of 1605 may be performed by a symbol configuration manager 1125 as described with reference to FIG. 11.

At 1610, the method may include transmitting DCI including a SFI, where the SFI indicates each of one or more symbols of the set of one or more symbols as TDD downlink symbols, TDD flexible symbols, or SBFD symbols. The operations of 1610 may be performed in accordance with examples as disclosed herein. In some examples, aspects of the operations of 1610 may be performed by an SFI transmission manager 1130 as described with reference to FIG. 11.

At 1615, the method may include performing wireless communication according to one or more of the configuration or the SFI. The operations of 1615 may be performed in accordance with examples as disclosed herein. In some examples, aspects of the operations of 1615 may be performed by a wireless communication performance manager 1135 as described with reference to FIG. 11.

The following provides an overview of aspects of the present disclosure:

Aspect 1: A method for wireless communications at a UE, comprising: receiving control signaling that indicates a configuration comprising a set of one or more SBFD symbols, wherein the set of one or more SBFD symbols are configured in one or more TDD downlink symbols or one or more TDD flexible symbols; monitoring for DCI comprising a SFI, wherein the SFI indicates each of one or more SBFD symbols of the set of one or more SBFD symbols as downlink, uplink, or flexible; and performing wireless communication according to one or more of the configuration or the SFI.

Aspect 2: The method of aspect 1, wherein the set of one or more SBFD symbols are configured in the one or more TDD downlink symbols or the one or more TDD flexible symbols by converting the one or more TDD downlink symbols or the one or more TDD flexible symbols to one or more SBFD symbols.

Aspect 3: The method of any of aspects 1 through 2, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as downlink, and wherein performing wireless communication comprises: receiving a downlink communication via one or more downlink subbands associated with the set of one or more SBFD symbols, wherein the downlink communication comprises one or more of a PDCCH transmission, a PDSCH transmission, a CSI-RS transmission, or a PRS transmission.

Aspect 4: The method of any of aspects 1 through 3, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as uplink, and wherein performing wireless communication comprises: transmitting an uplink communication via one or more uplink subbands associated with the set of one or more SBFD symbols, wherein the uplink communication comprises one or more of a PUCCH transmission, an PUSCH transmission, an SRS transmission, or a PRACH transmission.

Aspect 5: The method of any of aspects 1 through 4, wherein the SFI indicates each of one or more SBFD symbols of the set of one or more SBFD symbols as flexible, and wherein performing wireless communication comprises: receiving a downlink communication or transmitting an uplink communication based at least in part on a corresponding DCI, wherein receiving the downlink communication is based at least in part on canceling the uplink communication associated with one or more uplink subbands, and wherein transmitting the uplink communication is based at least in part on dropping the downlink communication associated with one or more downlink subbands.

Aspect 6: The method of any of aspects 1 through 5, wherein the configuration indicates that one or more SBFD symbols of the set of one or more SBFD symbols are configured in the one or more TDD downlink symbol, wherein the SFI indicates each of one or more SBFD symbols of the set of one or more SBFD symbols as flexible, and the method further comprising: refraining from receiving a downlink communication or transmitting an uplink communication via the set of one or more SBFD symbols indicated as flexible.

Aspect 7: The method of any of aspects 1 through 6, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as downlink, and wherein performing wireless communication comprises: receiving a downlink communication via one or more flexible subbands associated with the set of one or more SBFD symbols, wherein the downlink communication comprises one or more of a PDCCH transmission, an PDSCH transmission, a CSI-RS transmission, or a PRS transmission.

Aspect 8: The method of any of aspects 1 through 7, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein performing wireless communication comprises: receiving a downlink communication via one or more flexible subbands associated with the set of one or more SBFD symbols, wherein the downlink communication comprises one or more of a PDCCH transmission, an PDSCH transmission, a CSI-RS transmission, or a PRS transmission.

Aspect 9: The method of any of aspects 1 through 8, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein performing wireless communication comprises: transmitting an uplink communication via one or more uplink subbands associated with the set of one or more SBFD symbols, wherein the uplink communication comprises one or more of a PUCCH transmission, an PUSCH transmission, an SRS transmission, or a PRACH transmission configured by higher-layer signaling.

Aspect 10: The method of any of aspects 1 through 9, wherein the configuration indicates that one or more SBFD symbols of the set of one or more SBFD symbols as are configured in the one or more TDD flexible symbols, wherein the SFI indicates each of one or more SBFD symbols of the set of one or more SBFD symbols as uplink, and wherein performing wireless communication comprises: transmitting an uplink communication via one or more uplink subbands and one or more flexible subbands associated with the set of one or more SBFD symbols, wherein the uplink communication comprises one or more of a PUCCH transmission, an PUSCH transmission, an SRS transmission, or a PRACH transmission.

Aspect 11: The method of any of aspects 1 through 2, further comprising: determining an absence of the SFI that indicates each of one or more SBFD symbols of the set of one or more SBFD symbols as flexible.

Aspect 12: The method of any of aspects 1 through 11, wherein the configuration indicates that one or more SBFD symbols of the set of one or more SBFD symbols are configured in the one or more TDD downlink symbols or in the one or more TDD flexible symbols, wherein the SFI indicates each of one or more SBFD symbols of the set of one or more SBFD symbols as downlink, and wherein performing wireless communication comprises: receiving a downlink communication via one or more TDD downlink symbols based at least in part on the SFI indicates each of one or more SBFD symbols of the set of one or more SBFD symbols as downlink.

Aspect 13: The method of any of aspects 1 through 12, wherein the configuration indicates that one or more SBFD symbols of the set of one or more SBFD symbols are configured in the one or more TDD downlink symbols or in the one or more TDD flexible symbols, wherein the SFI indicates each of one or more SBFD symbols of the set of one or more SBFD symbols as flexible, and wherein performing wireless communication comprises: performing the wireless communication via the one or more SBFD symbols or one or more TDD flexible symbols.

Aspect 14: The method of any of aspects 1 through 13, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as uplink, and wherein performing wireless communication comprises: transmitting one or more messages via the one or more SBFD symbols.

Aspect 15: The method of any of aspects 1 through 14, wherein the configuration indicates that one or more SBFD symbols of the set of one or more SBFD symbols are configured in the one or more TDD flexible symbols or the one or more TDD downlink symbols, wherein the SFI indicates each of one or more SBFD symbols of the set of one or more SBFD symbols as uplink, wherein performing wireless communication comprises: performing an uplink communication irrespective of the SFI; or declaring an error associated with configuring the one or more SBFD symbols of the set of one or more SBFD symbols in the one or more TDD flexible symbols or the one or more TDD downlink symbols.

Aspect 16: A method for wireless communications at a UE, comprising: receiving control signaling that indicates a configuration comprising a set of one or more symbols, wherein the configuration indicates one or more symbols of the set of one or more symbols as downlink or flexible; receiving DCI comprising a SFI, wherein the SFI indicates each of one or more symbols of the set of one or more symbols as TDD downlink symbols, TDD flexible symbols, or SBFD symbols; and performing wireless communication according to one or more of the configuration or the SFI.

Aspect 17: The method of aspect 16, wherein the configuration comprises at least one SFI table comprising one or more entries indicatives of the set of one or more symbols as one or more of downlink, uplink, flexible, or SBFB.

Aspect 18: The method of any of aspects 16 through 17, further comprising: receiving a radio resource control signaling that indicates a second configuration comprising a set of one or more SBFD symbol patterns, wherein performing wireless communication is based at least in part on at least one SBFD symbol pattern of the set of one or more SBFD symbol patterns.

Aspect 19: The method of aspect 18, wherein the SFI comprises a bitfield that enables the at least one SBFD symbol pattern of the set of one or more SBFD symbol patterns.

Aspect 20: The method of any of aspects 18 through 19, wherein the at least one SBFD symbol pattern of the set of one or more SBFD symbol patterns is applicable to one or more symbols associated with the SFI, or the at least one SBFD symbol pattern is applicable until a second SFI enables at least one second SBFD symbol pattern of the set of one or more SBFD symbol patterns.

Aspect 21: A method for wireless communications at a network entity, comprising: transmitting control signaling that indicates a configuration comprising a set of one or more SBFD symbols, wherein the set of one or more SBFD symbols are configured in one or more TDD downlink symbols or one or more TDD flexible symbols; transmitting DCI comprising a SFI, wherein the SFI indicates each of one or more SBFD symbols of the set of one or more SBFD symbols as downlink, uplink, or flexible; and performing wireless communication according to one or more of the configuration or the SFI.

Aspect 22: The method of aspect 21, wherein the set of one or more SBFD symbols are configured in one or more TDD downlink symbols or one or more TDD flexible symbols by converting the one or more TDD downlink symbols or one or more TDD flexible symbols to one or more SBFD symbols.

Aspect 23: The method of any of aspects 21 through 22, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as downlink, and wherein performing wireless communication comprises: transmitting a downlink communication via one or more downlink subbands associated with the set of one or more SBFD symbols, wherein the downlink communication comprises one or more of a PDCCH transmission, an PDSCH transmission, a CSI-RS transmission, or a PRS transmission.

Aspect 24: The method of any of aspects 21 through 23, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as uplink, and wherein performing wireless communication comprises: receiving an uplink communication via one or more uplink subbands associated with the set of one or more SBFD symbols, wherein the uplink communication comprises one or more of a PUCCH transmission, an PUSCH transmission, an SRS transmission, or a PRACH transmission.

Aspect 25: The method of any of aspects 21 through 24, wherein the SFI indicates each of one or more SBFD symbols of the set of one or more SBFD symbols as flexible, and wherein performing wireless communication comprises: transmitting a downlink communication or receiving uplink communication based at least in part on a corresponding DCI, wherein transmitting the downlink communication is based at least in part on canceling the uplink communication associated with one or more uplink subbands, and wherein receiving the uplink communication is based at least in part on dropping the downlink communication associated with one or more downlink subbands.

Aspect 26: The method of any of aspects 21 through 25, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as downlink, and wherein performing wireless communication comprises: transmitting a downlink communication via one or more flexible subbands associated with the set of one or more SBFD symbols, wherein the downlink communication comprises one or more of a PDCCH transmission, an PDSCH transmission, a CSI-RS transmission, or a PRS transmission.

Aspect 27: The method of any of aspects 21 through 26, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein performing wireless communication comprises: transmitting a downlink communication via one or more flexible subbands associated with the set of one or more SBFD symbols, wherein the downlink communication comprises one or more of a PDCCH transmission, an PDSCH transmission, a CSI-RS transmission, or a PRS transmission.

Aspect 28: The method of any of aspects 21 through 27, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein performing wireless communication comprises: receiving an uplink communication via one or more uplink subbands associated with the set of one or more SBFD symbols, wherein the uplink communication comprises one or more of a PUCCH transmission, an PUSCH transmission, an SRS transmission, or a PRACH transmission configured by higher-layer signaling.

Aspect 29: The method of any of aspects 21 through 28, wherein the configuration indicates that one or more SBFD symbols of the set of one or more SBFD symbols as are configured in the one or more TDD flexible symbols, wherein the SFI indicates each of one or more SBFD symbols of the set of one or more SBFD symbols as uplink, and wherein performing wireless communication comprises: receiving an uplink communication via one or more uplink subbands and one or more flexible subbands associated with the set of one or more SBFD symbols, wherein the uplink communication comprises one or more of a PUCCH transmission, an PUSCH transmission, an SRS transmission, or a PRACH transmission.

Aspect 30: The method of any of aspects 21 through 29, wherein the configuration indicates that one or more SBFD symbols of the set of one or more SBFD symbols are configured in the one or more TDD downlink symbols or in the one or more TDD flexible symbols, wherein the SFI indicates each of one or more SBFD symbols of the set of one or more SBFD symbols as downlink, and wherein performing wireless communication comprises: transmitting a downlink communication via one or more TDD downlink symbols based at least in part on the SFI indicates each of one or more SBFD symbols of the set of one or more SBFD symbols as downlink.

Aspect 31: The method of any of aspects 21 through 30, wherein the configuration indicates that one or more SBFD symbols of the set of one or more SBFD symbols are configured in the one or more TDD downlink symbols or in the one or more TDD flexible symbols, wherein the SFI indicates each of one or more SBFD symbols of the set of one or more SBFD symbols as flexible, and wherein performing wireless communication comprises: performing the wireless communication via the one or more SBFD symbols or one or more TDD flexible symbols.

Aspect 32: The method of any of aspects 21 through 31, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as uplink, and wherein performing wireless communication comprises: receiving one or more messages via the one or more SBFD symbols.

Aspect 33: The method of any of aspects 21 through 32, wherein the configuration indicates that one or more SBFD symbols of the set of one or more SBFD symbols are configured in the one or more TDD flexible symbols or the one or more TDD downlink symbols, wherein the SFI indicates each of one or more SBFD symbols of the set of one or more SBFD symbols as uplink, wherein performing wireless communication comprises: performing an uplink communication irrespective of the SFI.

Aspect 34: A method for wireless communications at a network entity, comprising: transmitting control signaling that indicates a configuration comprising a set of one or more symbols, wherein the configuration indicates one or more symbols of the set of one or more symbols as downlink or flexible; transmitting DCI comprising a SFI, wherein the SFI indicates each of one or more symbols of the set of one or more symbols as TDD downlink symbols, TDD flexible symbols, or SBFD symbols; and performing wireless communication according to one or more of the configuration or the SFI.

Aspect 35: The method of aspect 34, wherein the configuration comprises at least one SFI table comprising one or more entries indicatives of the set of one or more symbols as one or more of downlink, uplink, flexible, or SBFB.

Aspect 36: The method of any of aspects 34 through 35, further comprising: transmitting a radio resource control signaling that indicates a second configuration comprising a set of one or more SBFD symbol patterns, wherein performing wireless communication is based at least in part on at least one SBFD symbol pattern of the set of one or more SBFD symbol patterns.

Aspect 37: The method of aspect 36, wherein the SFI comprises a bitfield that enables the at least one SBFD symbol pattern of the set of one or more SBFD symbol patterns.

Aspect 38: The method of any of aspects 36 through 37, wherein the at least one SBFD symbol pattern of the set of one or more SBFD symbol patterns is applicable to one or more symbols associated with the SFI, or the at least one SBFD symbol pattern is applicable until a second SFI enables at least one second SBFD symbol pattern of the set of one or more SBFD symbol patterns.

Aspect 39: A UE for wireless communications, comprising one or more memories storing processor-executable code, and one or more processors coupled with the one or more memories and individually or collectively operable to execute the code to cause the UE to perform a method of any of aspects 1 through 15.

Aspect 40: A UE for wireless communications, comprising at least one means for performing a method of any of aspects 1 through 15.

Aspect 41: A non-transitory computer-readable medium storing code for wireless communications, the code comprising instructions executable by one or more processors to perform a method of any of aspects 1 through 15.

Aspect 42: A UE for wireless communications, comprising one or more memories storing processor-executable code, and one or more processors coupled with the one or more memories and individually or collectively operable to execute the code to cause the UE to perform a method of any of aspects 16 through 20.

Aspect 43: A UE for wireless communications, comprising at least one means for performing a method of any of aspects 16 through 20.

Aspect 44: A non-transitory computer-readable medium storing code for wireless communications, the code comprising instructions executable by one or more processors to perform a method of any of aspects 16 through 20.

Aspect 45: A network entity for wireless communications, comprising one or more memories storing processor-executable code, and one or more processors coupled with the one or more memories and individually or collectively operable to execute the code to cause the network entity to perform a method of any of aspects 21 through 33.

Aspect 46: A network entity for wireless communications, comprising at least one means for performing a method of any of aspects 21 through 33.

Aspect 47: A non-transitory computer-readable medium storing code for wireless communications, the code comprising instructions executable by one or more processors to perform a method of any of aspects 21 through 33.

Aspect 48: A network entity for wireless communications, comprising one or more memories storing processor-executable code, and one or more processors coupled with the one or more memories and individually or collectively operable to execute the code to cause the network entity to perform a method of any of aspects 34 through 38.

Aspect 49: A network entity for wireless communications, comprising at least one means for performing a method of any of aspects 34 through 38.

Aspect 50: A non-transitory computer-readable medium storing code for wireless communications, the code comprising instructions executable by one or more processors to perform a method of any of aspects 34 through 38.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a configuration comprising a set of one or more subband full duplex (SBFD) symbols, wherein the set of one or more SBFD symbols are configured in one or more time division duplex (TDD) downlink symbols or one or more TDD flexible symbols;
monitor for downlink control information comprising a slot format indicator (SFI), wherein the SFI indicates each of one or more SBFD symbols of the set of one or more SBFD symbols as downlink, uplink, or flexible; and
perform wireless communication according to one or more of the configuration or the SFI.

2. The UE of claim 1, wherein the set of one or more SBFD symbols are configured in the one or more TDD downlink symbols or one or more TDD flexible symbols by converting the one or more TDD downlink symbols or one or more TDD flexible symbols to one or more SBFD symbols.

3. The UE of claim 1, the configuration indicates that one or more SBFD symbols of the set of one or more SBFD symbols are configured in the one or more TDD downlink symbols, wherein the SFI indicates each of one or more SBFD symbols of the set of one or more SBFD symbols as downlink, and wherein, to perform wireless communication, the one or more processors are individually or collectively operable to execute the code to cause the UE to:
receive a downlink communication via one or more downlink subbands associated with the set of one or more SBFD symbols,
wherein the downlink communication comprises one or more of a physical downlink control channel (PDCCH) transmission, a physical downlink shared channel (PDSCH) transmission, a channel state information reference signal (CSI-RS) transmission, or a positioning reference signal (PRS) transmission.

4. The UE of claim 1, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as uplink, and wherein, to perform wireless communication, the one or more processors are individually or collectively operable to execute the code to cause the UE to:
transmit an uplink communication via one or more uplink subbands associated with the set of one or more SBFD symbols,
wherein the uplink communication comprises one or more of a physical uplink control channel (PUCCH) transmission, a physical uplink shared channel (PUSCH) transmission, a sounding reference signal (SRS) transmission, or a physical random access channel (PRACH) transmission.

5. The UE of claim 1, wherein the SFI indicates each of one or more SBFD symbols of the set of one or more SBFD symbols as flexible, and wherein, to perform wireless communication, the one or more processors are individually or collectively operable to execute the code to cause the UE to:
receive a downlink communication or transmit an uplink communication based at least in part on a corresponding downlink control information,
wherein to receive the downlink communication is based at least in part on canceling the uplink communication associated with one or more uplink subbands, and wherein to transmit the uplink communication is based at least in part on dropping the downlink communication associated with one or more downlink subbands.

6. The UE of claim 1, wherein the configuration indicates that one or more SBFD symbols of the set of one or more SBFD symbols are configured in the one or more TDD downlink symbols, wherein the SFI indicates each of one or more SBFD symbols of the set of one or more SBFD symbols as flexible, and wherein the one or more processors are individually or collectively further operable to execute the code to cause the UE to:
refrain from receiving a downlink communication or transmitting an uplink communication via the set of one or more SBFD symbols indicated as flexible.

7. The UE of claim 1, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as downlink, and wherein, to perform wireless communication, the one or more processors are individually or collectively operable to execute the code to cause the UE to:
receive a downlink communication via one or more flexible subbands associated with the set of one or more SBFD symbols,
wherein the downlink communication comprises one or more of a physical downlink control channel (PDCCH) transmission, a physical downlink shared channel (PDSCH) transmission, a channel state information reference signal (CSI-RS) transmission, or a positioning reference signal (PRS) transmission.

8. The UE of claim 1, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein, to perform wireless communication, the one or more processors are individually or collectively operable to execute the code to cause the UE to:
receive a downlink communication via one or more flexible subbands associated with the set of one or more SBFD symbols,
wherein the downlink communication comprises one or more of a physical downlink control channel (PDCCH) transmission, a physical downlink shared channel (PDSCH) transmission, a channel state information reference signal (CSI-RS) transmission, or a positioning reference signal (PRS) transmission.

9. The UE of claim 1, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as flexible, and wherein, to perform wireless communication, the one or more processors are individually or collectively operable to execute the code to cause the UE to:
transmit an uplink communication via one or more uplink subbands associated with the set of one or more SBFD symbols,
wherein the uplink communication comprises one or more of a physical uplink control channel (PUCCH) transmission, a physical uplink shared channel (PUSCH) transmission, a sounding reference signal (SRS) transmission, or a physical random access channel (PRACH) transmission configured by higher-layer signaling.

10. The UE of claim 1, wherein the configuration indicates that one or more SBFD symbols of the set of one or more SBFD symbols as are configured in the one or more TDD flexible symbols, wherein the SFI indicates each of one or more SBFD symbols of the set of one or more SBFD symbols as uplink, and wherein, to perform wireless communication, the one or more processors are individually or collectively operable to execute the code to cause the UE to:
transmit an uplink communication via one or more uplink subbands and one or more flexible subbands associated with the set of one or more SBFD symbols,
wherein the uplink communication comprises one or more of a physical uplink control channel (PUCCH) transmission, a physical uplink shared channel (PUSCH) transmission, a sounding reference signal (SRS) transmission, or a physical random access channel (PRACH) transmission.

11. The UE of claim 1, wherein the one or more processors are individually or collectively further operable to execute the code to cause the UE to:
determine an absence of the SFI that indicates each of one or more SBFD symbols of the set of one or more SBFD symbols as flexible.

12. The UE of claim 1, wherein the configuration indicates that one or more SBFD symbols of the set of one or more SBFD symbols are configured in the one or more TDD downlink symbols or in the one or more TDD flexible symbols,
wherein the SFI indicates each of one or more SBFD symbols of the set of one or more SBFD symbols as downlink, and wherein, to perform wireless communication, the one or more processors are individually or collectively operable to execute the code to cause the UE to:
receive a downlink communication via one or more TDD downlink symbols based at least in part on the SFI indicates each of one or more SBFD symbols of the set of one or more SBFD symbols as downlink.

13. The UE of claim 1, wherein the configuration indicates that one or more SBFD symbols of the set of one or more SBFD symbols are configured in the one or more TDD downlink symbols or in the one or more TDD flexible symbols, wherein the SFI indicates each of one or more SBFD symbols of the set of one or more SBFD symbols as flexible, and wherein, to perform wireless communication, the one or more processors are individually or collectively operable to execute the code to cause the UE to:
perform the wireless communication via the one or more SBFD symbols or one or more TDD flexible symbols.

14. The UE of claim 1, wherein the configuration indicates that one or more SBFD symbols of the set of one or more SBFD symbols are configured in the one or more TDD flexible symbols, wherein the SFI indicates each of one or more SBFD symbols of the set of one or more SBFD symbols as uplink, and wherein, to perform wireless communication, the one or more processors are individually or collectively operable to execute the code to cause the UE to:
transmit one or more messages via the one or more SBFD symbols.

15. The UE of claim 1, wherein the configuration indicates that one or more SBFD symbols of the set of one or more SBFD symbols are configured in the one or more TDD flexible symbols or the one or more TDD downlink symbols, wherein the SFI indicates each of one or more SBFD symbols of the set of one or more SBFD symbols as uplink, and wherein, to perform wireless communication, the one or more processors are individually or collectively operable to execute the code to cause the UE to:
perform an uplink communication irrespective of the SFI; or
declare an error associated with configuring the one or more SBFD symbols of the set of one or more SBFD symbols in the one or more TDD flexible symbols or the one or more TDD downlink symbols.

16. A user equipment (UE), comprising:
one or more memories storing processor-executable code; and
one or more processors coupled with the one or more memories and individually or collectively operable to execute the code to cause the UE to:
receive control signaling that indicates a configuration comprising a set of one or more symbols, wherein the configuration indicates one or more symbols of the set of one or more symbols as downlink or flexible;
receive downlink control information comprising a slot format indicator (SFI), wherein the SFI indicates each of one or more symbols of the set of one or more symbols as time division duplexing (TDD) downlink symbols, TDD flexible symbols, or subband full duplex (SBFD) symbols; and
perform wireless communication according to one or more of the configuration or the SFI.

17. The UE of claim 16, wherein the configuration comprises at least one SFI table comprising one or more entries indicatives of the set of one or more symbols as one or more of downlink, uplink, flexible, or SBFB.

18. The UE of claim 16, wherein the one or more processors are individually or collectively further operable to execute the code to cause the UE to:
receive a radio resource control signaling that indicates a second configuration comprising a set of one or more SBFD symbol patterns,
wherein to perform wireless communication is based at least in part on at least one SBFD symbol pattern of the set of one or more SBFD symbol patterns and wherein the SFI comprises a bitfield that enables the at least one SBFD symbol pattern of the set of one or more SBFD symbol patterns.

19. The UE of claim 18, wherein the at least one SBFD symbol pattern of the set of one or more SBFD symbol patterns is applicable to one or more symbols associated with the SFI, or the at least one SBFD symbol pattern is applicable until a second SFI enables at least one second SBFD symbol pattern of the set of one or more SBFD symbol patterns.

20. A method for wireless communications at a user equipment (UE), comprising:
receiving control signaling that indicates a configuration comprising a set of one or more subband full duplex (SBFD) symbols, wherein the set of one or more SBFD symbols are configured in one or more time division duplex (TDD) downlink symbols or one or more TDD flexible symbols;
monitoring for downlink control information comprising a slot format indicator (SFI), wherein the SFI indicates each of one or more SBFD symbols of the set of one or more SBFD symbols as downlink, uplink, or flexible; and
performing wireless communication according to one or more of the configuration or the SFI.
